(19) United States
(12) Patent Application Publication
(10) Pub. No.: US 2023/0249178 A1
(43) Pub. Date: Aug. 10, 2023

(54) SPLIT-POOL SYNTHESIS APPARATUS AND METHODS OF PERFORMING SPLIT-POOL SYNTHESIS

(71) Applicant: ROCHE SEQUENCING SOLUTIONS, INC., Pleasanton, CA (US)

(72) Inventor: Garry P. NOLAN, Redwood City, CA (US)

(21) Appl. No.: 18/012,603

(22) PCT Filed: Jul. 8, 2021
(86) PCT No.: PCT/EP2021/068954

§ 371 Date: Dec. 22, 2022

Related U.S. Application Data
(60) Provisional application No. 63/049,201, filed on Jul. 8, 2020.

(51) Int. Cl. B01L 3/00

(52) U.S. Cl. CPC B01L 3/502715; B01L 3/50273; B01L 3/502761; B01L 2200/0621; B01L 2300/0838; B01L 2300/0893; B01L 2300/123; B01L 2200/16; B01L 2400/0487; B01L 2200/021

(57) ABSTRACT

Described herein are systems and methods for dividing a population of particles into two or more subpopulations, reacting each formed subpopulation of particles with a different reagent, pooling the reacted subpopulations of particles back together.

### BACKGROUND OF THE DISCLOSURE

Driven by recent advances in flow cytometry and RNA/DNA sequencing, significant progress has been achieved in single-cell characterization. Microfluidic systems including cell sorters and micro-well reactors have been employed to separate tens of thousands of cells into isolated compartments where their mRNAs are reverse transcribed and amplified for sequencing. Significant enhancement in throughput, however, is needed to enable analysis of millions of individual cells, which is necessary to identify all different cell types and to fully understand their function and their response to changes in the microenvironment. Future improvements in cell manipulation and isolation of cells in separate compartments will likely come with a considerable increase in complexity and the cost of instrumentation.

An alternative approach to single cell analysis that does not require partitioning and confinement involves employing molecular tags to identify reads from individual cells, such as through ensemble processing in conventional microwell plates while retaining single-cell resolution. Unique barcodes are assigned to each cell by split-pool barcoding (SPBC) or quantum barcoding (QBC). This can be done, for example, by labeling each cell's mRNAs during reverse transcription or by labeling cell-specific antibodies with specific DNA oligonucleotides. In each split-pool cycle, fixed cells or nuclei are divided into N wells containing specific barcodes as shown in FIG. 1A.

After barcodes are appended through ligation, the unattached barcodes are washed away, and the cells or nuclei are pooled together. The process can be repeated multiple times by redistributing the cells or nuclei into the same or another set of the wells. This process is repeated a sufficient number of times to reach high probability that each cell or nucleus in the final pool holds a unique barcode. For example, if “m” number of cells or nuclei are started with and are then split them into “N” wells, and if the process is repeated “X” times, then the “m” different number of cells or nuclei will be eventually sharing “N^{X}” unique barcodes.

Since the number of unique tags grows exponentially with the number of barcoding rounds, significant throughput enhancement can be achieved simply by adding a few additional cycles. It is believed, however, that using larger micro-well plates does not reduce the number of needed QBC cycles dramatically, but it does add a significant number of pipetting steps (see FIGS. 1B and 1C). For these processes, the optimal size of a micro-well plate used in conventional QBC is determined by: (1) the efficiency of ligation and/or reverse transcription reactions, (2) the losses of cellular material during pipetting between different micro-wells and various washing and rinsing steps needed to remove the unbound tags and other reagents, and, ultimately, (3) by the cost of sequencing which limits the length of the barcodes and hence the number of allowed QBC cycles.

While QBC can certainly be performed in micro-well plates by liquid handling robots to achieve ultra-high-throughput analysis of single cells, the non-parallel nature of liquid manipulation makes conventional automated platforms not is particularly ideal for QBC protocol. For example, a QBC process performed in four micro-wells requires eight sequential pipetting steps as shown schematically in FIG. 1D. Depending on the micro-well plate size, it is believed that a full QBC process could require between 200 and 18,500 pipetting steps to move cells around the microarray with a single pipette tip moving at any one time. It will be appreciated that each of these pipetting steps potentially contributes to a loss of material and genetic information. In addition, cost of materials, such as pipette tips and other consumables is a significant factor in such robotics, and where possible these costs should be minimized.

### BRIEF SUMMARY OF THE DISCLOSURE

Applicant has developed a split-pooling apparatus and method capable of dividing a population of particles into two or more reaction vessels, independently reacting each population of divided particles with a separate reagent in the two or more reaction vessels, and pooling the divided populations of particles back together simultaneously, repeatedly, and without considerable material losses. In some embodiments, the devices and methods of the present disclosure are adapted for performing any number of chemical reactions and/or chemical synthesis. In some embodiments, the devices and methods of the present disclosure are adapted for split-pool synthesis, split-pool barcoding, and/or quantum barcoding.

In some embodiments, the devices and methods of the present disclosure are suitable for use in labeling particles with a statistically unique barcode, where the statistically unique barcode is iteratively generated after repeated split-pool synthesis cycle. In some embodiments, the statistically unique barcodes include concatenated nucleic acid sequences. In some embodiments, the split-pooling apparatus of the present disclosure facilitates the implementation of the quantum barcoding protocol described in the U.S. Pat. No. 10,144,950, the disclosure of which is hereby incorporated by reference herein in its entirety.

A first aspect of the present disclosure is a split-pooling apparatus comprising: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module.

In some embodiments, the nib comprises between 4 and 128 independently operable channels. In some embodiments, the nib comprises between 8 and 64 independently operable channels. In some embodiments, the nib comprises between 12 and 32 independently operable channels.

In some embodiments, the plurality of independently operable channels are tubes. In some embodiments, the tubes have a volume ranging from between about 1 μL to about 10 mL. In some embodiments, the tubes have a volume ranging from between about 250 μL to about 1 mL. In some embodiments, the tubes have a volume ranging from between about 500 μL to about 1 mL.

In some embodiments, the plurality of independently operable channels are capillary channels. In some embodiments, the capillary channels have a volume ranging from between about 0.5 μL to about 500 μL. In some embodiments, the capillary channels have a volume ranging from between about 1 μL to about 500 μL. In some embodiments, the capillary channels have a volume ranging from between about 10 μL to about 250 μL.

In some embodiments, the plurality of independently operable channels are loaded with a reagent. In some embodiments, the reagent is a liquid. In some embodiments, the reagent is a solid. In some embodiments, each of the plurality of independently operable channels are loaded with a different reagent.

In some embodiments, the split-pooling apparatus further comprises a loading device. In some embodiments, the loading device includes one or more loading channels. In some embodiments, the loading device and/or the loading channels include features that are complementary to features of the nib and/or the one or more channels present within the nib. For instance, a size and/or shape of the loading device and/or the loading channels may be complementary to a size and/or shape of the nib and/or the channels present within the nib, such that the loading device may be used to transfer reagents to the channels present within the nib. In some embodiments, the loading device comprises between 4 and 128 loading channels, where each of the loading channels include openings which have sizes and/or shapes which are complementary to openings in the channels within the nib. In some embodiments, the loading device further comprises an injector mechanism, such as an injector mechanism used to transfer one or more fluids, reagents, and/or particles from the one or more loading channels to corresponding channels of the nib.

In some embodiments, the split-pooling apparatus comprises a plurality of nibs and a plurality of complementary wells. In some embodiments, the plurality of nibs are coupled together as an assembly, wherein the assembly includes at least one row of nibs.

A second aspect of the present disclosure is a split-pooling apparatus comprising: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module.

In some embodiments, each depression of the plurality of depressions has a volume ranging from between about 100 μL to about 1 mL. In some embodiments, each depression of the plurality of depressions has a volume ranging from between about 500 μL to about 1 mL. In some embodiments, each of the plurality of depressions have a first opening and a second opening. In some embodiments, the second opening is in fluidic communication with a vacuum source.

In some embodiments, the elastomeric sheet is supported by a plurality of staves. In some embodiments, the split-pooling device further comprises a force generating member. In some embodiments, each of the plurality of depressions are each circumscribed by a trough. In some embodiments, the force generating member is a movable grate, wherein the movable grate comprises a plurality of elements which are complementary to and fit within the troughs circumscribing each of the depressions. In some embodiments, the movable grate is movable from a first position proximal the elastomeric sheet to a second position in contact with the elastomeric sheet. In some embodiments, the movable grate is further movable to a third position such that the elastomeric sheet at least partially contacts a bottom of a trough.

In some embodiments, each depression of the plurality of depressions is proximal to at least two indentations. In some embodiments, the force generating member is a movable element comprising a plurality of protuberances adapted to fit within the indentations. In some embodiments, the movable element is movable from a first position proximal the elastomeric sheet to a second position where each protuberance is in contact with the elastomeric sheet. In some embodiments, the movable element is further movable to a third position such that the elastomeric sheet at least partially contacts a bottom of a trough.

In some embodiments, the elastomeric sheet comprises a plurality of compartments. In some embodiments, the elastomeric sheet comprises between 8 and 64 compartments. In some embodiments, the elastomeric sheet comprises between 8 and 32 compartments. In some embodiments, each compartment of the plurality of compartments comprises a volume ranging from between 1 μL to about 1 mL.

In some embodiments, the elastomeric sheet comprises a Young's modulus of less than 6 MPa. In some embodiments, the elastomeric sheet comprises a Young's modulus of less than 3 MPa. In some embodiments, the elastomeric sheet comprises a Young's modulus of less than 1 MPa.

In some embodiments, the elastomeric sheet is comprised of a material selected from a silicone, a latex, a natural rubber, a synthetic rubber, a nitrile, a polyethylene terephthalate, a polyurethane, a flexible polyvinyl chloride, a styrene-ethylene-butylene-styrene, or an ethylene vinyl acetate or a blend or mixture thereof.

A third aspect of the present disclosure is a split-pooling apparatus comprising: (i) a split-pooling array including (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

In some embodiments, the partitioning element is movable between a first position proximal the tray to a second position where at least a bottom surface of the partitioning element is in at least partial contact with an interior surface of the tray. In some embodiments, the partitioning element forms a liquid-tight seal with the tray. In some embodiments, the split-pooling array comprises a plurality of compartments. In some embodiments, the split-pooling array comprises between 8 and 64 compartments. In some embodiments, each compartment has a volume ranging from between about 1 μL to about 10 mL. In some embodiments, each compartment has a volume ranging from between about 10 μL to about 1 mL.

A fourth aspect of the present disclosure is a population of uniquely functionalized particles prepared using a split-pooling apparatus, wherein the split-pooling apparatus comprising: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module.

A fifth aspect of the present disclosure is a population of uniquely functionalized particles prepared using a split-pooling apparatus, wherein the split-pooling apparatus comprising: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module.

A sixth aspect of the present disclosure is a population of uniquely functionalized particles prepared using a split-pooling apparatus, wherein the split-pooling apparatus comprising: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

A seventh aspect of the present disclosure is a method of functionalizing particles with one or more reagents, comprising dividing a population of particles into two or more subpopulations by flowing, trapping, and/or corralling the particles into a plurality of different reaction vessels of a split-pooling array; reacting each subpopulation of particles with a different reagent to provide two or more reacted subpopulations of particles; and pooling the two or more reacted subpopulations of particles together in a pooling vessel. In some embodiments, the particles are randomly or deterministically divided into the two or more subpopulations. In some embodiments, the reacted two or more subpopulations of particles are randomly or deterministically pooled together.

In some embodiments, the reaction vessels are channels. In some embodiments, the channels are tubes. In some embodiments, the channels are capillary channels. In some embodiments, the reaction vessels are compartments formed within a tray. In some embodiments, the reaction vessels are compartments formed on the surface of an elastomeric sheet.

In some embodiments, the method further comprises introducing one or more reagents to each of the different reaction vessels. In some embodiments, the one or more reagents are liquids. In some embodiments, the one or more reagents are solids. In some embodiments, the one or more reagents are introduced using one or more dispensing devices. In some embodiments, the dispensing devices are pipettes. In some embodiments, the dispensing devices are microfluidic applicators.

An eighth aspect of the present disclosure is a method of functionalizing particles with one or more reagents, comprising: (a) flowing a population of particles in a fluid through a plurality of channels of a split-pooling array, wherein the flowing of the population of particles through the plurality of channels randomly or deterministically divides the population of particles into two or more subpopulations of particles; (b) contacting each of the two or more subpopulations of particles with a different reagent introduced to each channel of the plurality of channels to provide two or more subpopulations of reacted particles; and (c) randomly or deterministically pooling the two or more reacted subpopulations of particles together into a pooling vessel to form a pool of reacted particles. In some embodiments, steps (a), (b), and (c) are repeated sequentially a predetermined number of times.

In some embodiments, the channels are tubes. In some embodiments, the tubes have a volume ranging from between about 1 μL to about 10 mL. In some embodiments, the tubes have a volume ranging from between about 500 μL to about 1 mL.

In some embodiments, the channels are capillary channels. In some embodiments, the capillary channels have a volume ranging from between about 0.5 μL to about 500 μL. In some embodiments, the capillary channels have a volume ranging from between about 10 μL to about 250 μL. In some embodiments, each channel of the plurality of channels are pre-loaded with a different reagent.

In some embodiments, the method further comprises transferring one or more reagents from a plurality of loading channels to each of the plurality of channels of the split-pooling array.

A ninth aspect of the present disclosure is a method of functionalizing particles with one or more reagents, comprising: (a) randomly or deterministically dividing a population of particles into two or more subpopulations of particles, wherein the dividing of the population of particles comprises trapping each of the two or more subpopulation particles within a compartment formed within a tray of a split-pooling array; (b) contacting each of the two or more subpopulations of particles with a different reagent introduced to each of the formed compartments to provide two or more subpopulations of reacted particles; and (c) randomly or deterministically pooling the two or more reacted subpopulations of particles together into a pooling vessel to form a pool of reacted particles. In some embodiments, steps (a), (b), and (c) are repeated sequentially a predetermined number of times.

In some embodiments, the trapping of the two or more subpopulations of particles comprises introducing a partitioning element into the tray of the split-pooling array. In some embodiments, the partitioning element comprises a grid-like pattern of elements. In some embodiments, the split-pooling array comprises between 8 and 64 formed compartments.

A tenth aspect of the present disclosure is a method of functionalizing particles with one or more reagents, comprising: (a) randomly or deterministically dividing a population of particles into two or more subpopulations of particles, wherein the dividing of the population of particles comprises corralling each of the two or more subpopulation particles within a compartment formed on the surface of an elastomeric sheet of a split-pooling array; (b) contacting each of the two or more subpopulations of particles with a different reagent introduced to each of the compartments to provide two or more subpopulations of reacted particles; and (c) randomly or deterministically pooling the two or more reacted subpopulations of particles together into a pooling vessel to form a pool of reacted particles. In some embodiments, steps (a), (b), and (c) are repeated sequentially a predetermined number of times.

In some embodiments, the corralling of the two or more subpopulations of particles comprises contacting the elastomeric sheet with a force generating member. In some embodiments, the force generating member is a movable grid having a plurality of elements arranged in a grid-like pattern. In some embodiments, the force generating member is a movable element comprising a plurality of protuberances.

An eleventh aspect of the present disclosure is a kit comprising the split-pooling apparatus and a sequencing device. In some embodiments, the split-pooling apparatus comprises (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module. In some embodiments, the split-pooling apparatus comprises: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module. In some embodiments, the split-pooling apparatus comprises: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

A twelfth aspect of the present disclosure is a kit comprising the split-pooling apparatus and a chip for conducting a polymerase chain reaction, including but not limited to a digital droplet polymerase chain (ddPCR) reaction. In some embodiments, the split-pooling apparatus comprises: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module. In some embodiments, the split-pooling apparatus comprises: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module. In some embodiments, the split-pooling apparatus comprises: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

A thirteenth aspect of the present disclosure is a kit comprising the split-pooling apparatus and one or more reagents. In some embodiments, the split-pooling apparatus comprises: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module. In some embodiments, the split-pooling apparatus comprises: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module. In some embodiments, the split-pooling apparatus comprises: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

A fourteenth aspect of the present disclosure is a split-pooling apparatus for use in performing split-pool synthesis. In some embodiments, the split-pool synthesis comprises labeling a particle with a unique barcode. In some embodiments, the particle is a cell. In some embodiments, the particle is a constituent of a cell. In some embodiments, the particle is a biopolymer. In some embodiments, the split-pooling apparatus comprises: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module. In some embodiments, the split-pooling apparatus comprises: (i) a split-pooling array having (a) a plate comprising a plurality of depressions arranged in a grid-like pattern, and (b) an elastomeric sheet covering each of the plurality of depressions; (ii) a fluidics module in fluidic communication with the split-pooling array; and (iii) a control system in communication with the fluidics module. In some embodiments, the split-pooling apparatus comprises: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

### BRIEF DESCRIPTION OF THE FIGURES

For a general understanding of the features of the disclosure, reference is made to the drawings. In the drawings, like reference numerals have been used throughout to identify identical elements.

FIG. 1A is a schematic representation of split-pool barcoding. The number of unique barcodes grows exponentially with the number of barcoding rounds.

FIG. 1B illustrates the calculated numbers of split-pool cycles.

FIG. 1C illustrates the number of pipetting steps needed to avoid barcode collisions for various cell populations and micro-well plate sizes.

FIG. 1D depicts a conventional fluidic manipulation in a quantum barcoding protocol.

FIG. 2 depicts a split-pooling apparatus including a split-pooling array, a controller, a fluidics module, and a reservoir in accordance with one embodiment of the present disclosure.

FIG. 3A illustrates a channel-based split-pooling array including a plurality of channels housed within a nib; the nib is depicted as inserted within a well in accordance with one embodiment of the present disclosure.

FIGS. 3B and 3C illustrates a nib assembly, where the nib assembly includes a plurality of nibs, each nib including a plurality of channels in accordance with one embodiment of the present disclosure.

FIG. 3D illustrates a plate including a series of wells, where each well is configured to accept a nib.

FIG. 3E depicts a loading device having a plurality of loading channels in fluidic communication with each of the respectively channels of a nib. FIG. 3E also illustrates a plurality of plungers positioning within each loading channel configured to transfer the reagents from the loading channels to each of the respective channels of the nib in accordance with one embodiment of the present disclosure.

FIG. 4A illustrates a top down view of a plate having a plurality of depressions in accordance with one embodiment of the present disclosure.

FIGS. 4A, 4B, and 4C each illustrate a side view of a plate having a plurality of depressions in accordance with one embodiment of the present disclosure.

FIG. 5A illustrates a top down view of a plate having a plurality of depressions in accordance with one embodiment of the present disclosure.

FIGS. 5B, 5C, and 5D each illustrate a side view of a plate having a plurality of depressions in accordance with one embodiment of the present disclosure.

FIG. 6A illustrates a top down view of a movable grate in accordance with one embodiment of the present disclosure.

FIG. 6B illustrates a side view of a movable grate in accordance with one embodiment of the present disclosure.

FIG. 7 illustrates a movable element including a plurality of protuberances in accordance with one embodiment of the present disclosure.

FIG. 8A depicts a perspective view of a plate having a plurality of depressions, where each depression is at least partially surrounded by a trough. FIG. 8A also depicts an elastomeric sheet being positioned over the top of the plate.

FIG. 8B provides a perspective view of an elastomeric sheet positioned over the top of a plate. The figure further illustrates that the elastomeric sheet may serve as a pooling vessel. As depicted, a pool comprising multiple populations of particles may be deposited on the surface of the elastomeric sheet.

FIG. 8C provides a perspective view of an elastomeric sheet following the application of one or more predetermined forces to one or more predetermined positions along the elastomeric sheet. The application of the one or more predetermined forces facilitates the formation of a plurality of reaction vessels, i.e. the formation of a plurality of compartments each including a subpopulation of particles which may be independently reacted with one or more reagents.

FIG. 9A depicts a top down view of a tray in accordance with one embodiment of the present disclosure.

FIG. 9B illustrates a top down view of a partitioning element in accordance with one embodiment of the present disclosure.

FIG. 9C illustrates a side view of a partitioning element in accordance with one embodiment of the present disclosure.

FIG. 9D illustrates a side view of a partitioning element provided within a tray in accordance with one embodiment of the present disclosure.

FIG. 9E illustrates a top down view of a partitioning element provided within a tray in accordance with one embodiment of the present disclosure.

FIG. 9F illustrates a perspective view of a partitioning element provided within a tray in accordance with one embodiment of the present disclosure.

FIG. 10 provides a flow chart illustrating a method of collecting populations of reacted particles in accordance with one embodiment of the present disclosure.

FIG. 11 provides a flow chart illustrating a method of performing split-pooling synthesis using a channel-based split-pooling array in accordance with one embodiment of the present disclosure.

FIG. 12 provides a flow chart illustrating a method of performing split-pooling synthesis using a virtual compartment-based split-pooling array in accordance with one embodiment of the present disclosure.

FIG. 13 provides a flow chart illustrating a method of performing split-pooling synthesis using a partitionable split-pooling array in accordance with one embodiment of the present disclosure.

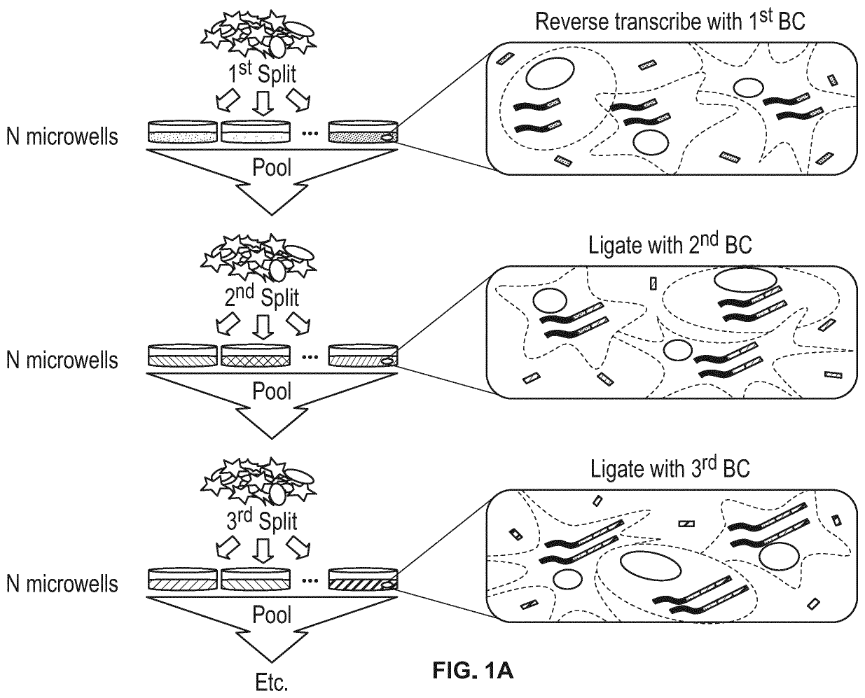

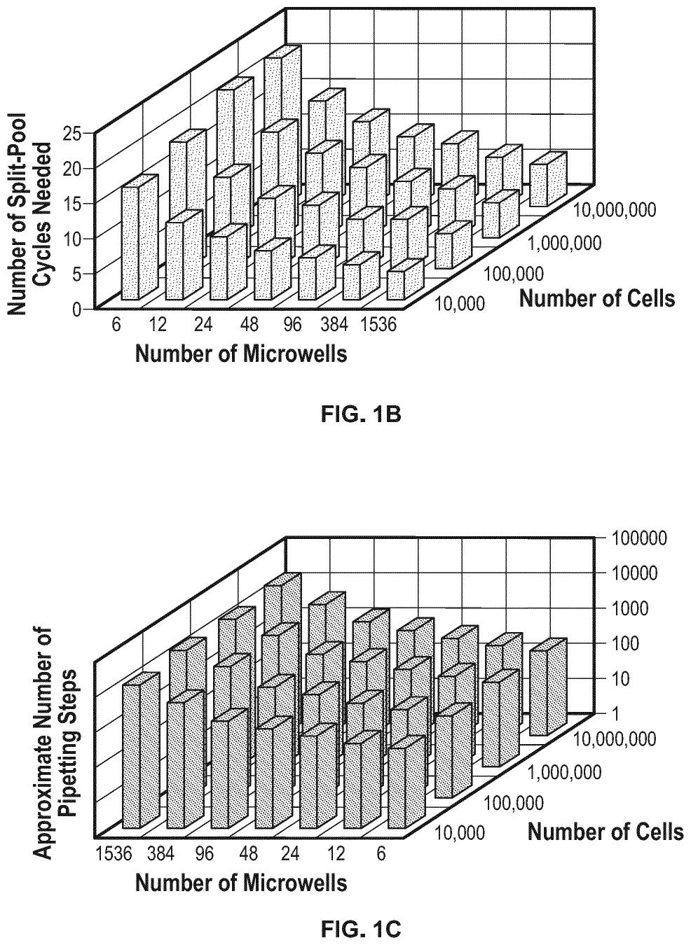

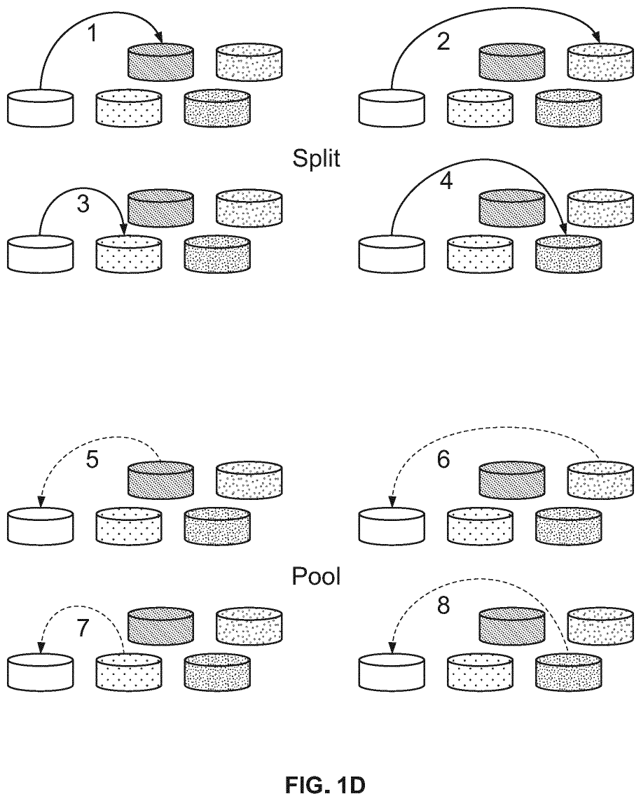

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, for example, the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (for example “one or the other but not both”) when preceded by terms of exclusivity, such as “either,” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein, the terms “Cell Origination Barcode” and “COB” each refer to a unique code that can be associated to a specific cell of origin. In some embodiments, upon binding of the COB to a common linker moiety (e.g. common linker oligo) associated with an ESB, the COB code identifies the cells of origin of the target molecule to which the UBA/ESB complex is bound. Thus, in some embodiments, the COBs of the disclosure comprise two main portions: (i) a sequence specific for a common linker moiety (e.g. common linker oligo) associated with a UBA/ESB probe; and (ii) an unique code that can be associated to a specific cell of origin. In some embodiments, COBs are modular structures. In some embodiments, the COB comprises a plurality of different assayable polymer subunits (APS). In some embodiments, the COBs comprise a plurality of APSs attached in linear combination. In some embodiments, a COB is a molecular entity containing certain basic elements: (i) a plurality of APSs including label attachment regions attached in linear combination to form a backbone, and (ii) complementary polynucleotide sequences, including a label, which are complementary and are attached to the label attachment regions of the backbone. The term “label attachment region” includes a region of defined polynucleotide sequence within a given backbone that may serve as an individual attachment point for a detectable molecule. In some embodiments, the COBs comprise a plurality of different APSs attached in linear combination, wherein the APSs comprise small molecules of deterministic weight. In some embodiments, the COB comprises 2, 3, 4, 5, 6, 7, 8, 9, 10 or more unique APSs attached in a linear combination. In some embodiments, the COB comprises 4 or more APSs attached in linear combination. UBAs, ESB, and COBs are further described herein and in U.S. Pat. No. 10,144,950, the disclosure of which is hereby incorporated by reference herein in its entirety.

As used herein, the term “cell,” refers to a prokaryotic cell or a eukaryotic cell. The cell may be an adherent or a non-adherent cell, such as an adherent prokaryotic cell, adherent eukaryotic cell, non-adherent prokaryotic cell, or non-adherent eukaryotic cell. A cell may be a yeast cell, a bacterial cell, an algae cell, a fungal cell, or any combination thereof. A cell may be a mammalian cell. A cell may be a primary cell obtained from a subject. A cell may be a cell line or an immortalized cell. A cell may be obtained from a mammal, such as a human or a rodent. A cell may be a cancer or tumor cell. A cell may be an epithelial cell. A cell may be a red blood cell or a white blood cell. A cell may be an immune cell such as a T cell, a B cell, a natural killer (NK) cell, a macrophage, a dendritic cell, or others. A cell may be a neuronal cell, a glial cell, an astrocyte, a neuronal support cell, a Schwann cell, or others. A cell may be an endothelial cell. A cell may be a fibroblast or a keratinocyte. A cell may be a pericyte, hepatocyte, a stem cell, a progenitor cell, or others. A cell may be a circulating cancer or tumor cell or a metastatic cell. A cell may be a marker specific cell such as a CD8+ T cell or a CD4+ T cell. A cell may be a neuron. A neuron may be a central neuron, a peripheral neuron, a sensory neuron, an interneuron, a intraneuronal, a motor neuron, a multipolar neuron, a bipolar neuron, or a pseudo-unipolar neuron. A cell may be a neuron supporting cell, such as a Schwann cell. A cell may be one of the cells of a blood-brain barrier system. A cell may be a cell line, such as a neuronal cell line. A cell may be a primary cell, such as cells obtained from a brain of a subject. A cell may be a population of cells that may be isolated from a subject, such as a tissue biopsy, a cytology specimen, a blood sample, a fine needle aspirate (FNA) sample, or any combination thereof. A cell may be obtained from a bodily fluid such as urine, milk, sweat, lymph, blood, sputum, amniotic fluid, aqueous humor, vitreous humor, bile, cerebrospinal fluid, chyle, chyme, exudates, endolymph, perilymph, gastric acid, mucus, pericardial fluid, peritoneal fluid, pleural fluid, pus, rheum, saliva, sebum, serous fluid, smegma, sputum, tears, vomit, or other bodily fluid. A cell may comprise cancerous cells, non-cancerous cells, tumor cells, non-tumor cells, healthy cells, or any combination thereof.

As used herein, the term “channel” refers to an enclosed passage within a split-pooling array through which a fluid can flow, e.g. by capillary action, or through the application of a negative pressure (vacuum). In some embodiments, a channel may have one or more openings for introduction of a fluid. In some embodiments, a channel may include a coating, e.g. a hydrophilic or hydrophobic coating to further facilitate fluid flow. In some embodiments, a channel may include features or chemical adducts which enable coating of reagents via drying, a temperature sensitive release function, or a chemistry-sensitive release function (pH, ions, electrical). Examples of channels include tubes and capillary channels. In some embodiments, a channel may be a passage provided within a microfluidic element.

As used herein, the terms “Epitope Specific Barcode” or “ESB” refer to unique codes that can be associated to a specific target molecule. ESBs are molecules or assemblies that are designed to bind with at least one UBA (defined herein) or part of an UBA; and can, under appropriate conditions, form a molecular complex including the ESB, the UBA and the target molecule. ESBs can comprise at least one identity identification portion that allow them to bind to or interact with at least one UBA; typically in a sequence-specific, a confirmation-specific manner, or both; for example but not limited to UBA-antibody binding, aptamer-target binding, and the like. In some embodiments, the ESB are attached, directly or indirectly, to the UBA. In other embodiments, the ESBs bind to the UBAs in a cell or sample, e.g., as part of the assay procedure. UBAs and ESB are further described herein and in U.S. Pat. No. 10,144,950, the disclosure of which is hereby incorporated by reference herein in its entirety.

As used herein, the term “fluid” refers to any liquid or liquid composition, including water, solvents, buffers, solutions (e.g. polar solvents, non-polar solvents), and/or mixtures. The fluid may be aqueous or non-aqueous. Non-limiting examples of fluids include washing solutions, rinsing solutions, acidic solutions, alkaline solutions, transfer solutions, and hydrocarbons (e.g., alkanes, isoalkanes and aromatic compounds such as xylene). In some embodiments, washing solutions include a surfactant to facilitate spreading of the washing liquids over the specimen-bearing surfaces of the slides. In some embodiments, acid solutions include deionized water, an acid (e.g., acetic acid), and a solvent. In some embodiments, alkaline solutions include deionized water, a base, and a solvent. In some embodiments, transfer solutions include one or more glycol ethers, such as one or more propylene-based glycol ethers (e.g., propylene glycol ethers, di(propylene glycol) ethers, and tri(propylene glycol) ethers, ethylene-based glycol ethers (e.g., ethylene glycol ethers, di(ethylene glycol) ethers, and tri(ethylene glycol) ethers), and functional analogs thereof. Non-liming examples of buffers include citric acid, potassium dihydrogen phosphate, boric acid, diethyl barbituric acid, piperazine-N,N′-bis(2-ethanesulfonic acid), dimethylarsinic acid, 2-(N-morpholino)ethanesulfonic acid, tris(hydroxymethyl)methylamine (TRIS), 2-(N-morpholino)ethanesulfonic acid (TAPS), N,N-bis(2-hydroxyethyl)glycine(Bicine), N-tris(hydroxymethyl)methylglycine (Tricine), 4-2-hydroxyethyl-1-piperazineethanesulfonic acid (HEPES), 2-{[tris(hydroxymethyl)methyl]amino}ethanesulfonic acid (TES), and combinations thereof. In some embodiments, the unmasking agent is water. In other embodiments, the buffer may be comprised of tris(hydroxymethyl)methylamine (TRIS), 2-(N-morpholino)ethanesulfonic acid (TAPS), N,N-bis(2-hydroxyethyl)glycine(Bicine), N-tris(hydroxymethyl)methylglycine (Tricine), 4-2-hydroxyethyl-1-piperazineethanesulfonic acid (HEPES), 2-{[tris(hydroxymethyl)methyl]amino}ethanesulfonic acid (TES), or a combination thereof. Additional wash solutions, transfer solutions, acid solutions, and alkaline solutions are described in United States Patent Application Publication No. 2016/0282374, the disclosure of which is hereby incorporated by reference herein in its entirety.

As used herein, the term “oligonucleotide” refers to an oligomer of nucleotide or nucleoside monomer units wherein the oligomer optionally includes non-nucleotide monomer units, and/or other chemical groups attached at internal and/or external positions of the oligomer. The oligomer can be natural or synthetic and can include naturally-occurring oligonucleotides, or oligomers that include nucleosides with non-naturally-occurring (or modified) bases, sugar moieties, phosphodiester-analog linkages, and/or alternative monomer unit chiralities and isomeric structures (e.g., 5′- to 2′-linkage, L-nucleosides, α-anomer nucleosides, β-anomer nucleosides, locked nucleic acids (LNA), peptide nucleic acids (PNA)).

As used herein, “particles” include natural and/or synthetic chemicals (small molecules) or biological molecules. Non-limiting examples of particles include cells, components of cells, nuclei, organelles, beads, nanoparticles, magnetic or paramagnetic microspherical polymer-coated particles, biopolymers, agglomerates, chemicals with functionalities that allow addition of barcodes (RNA, DNA, DNA-like polymers, small molecule dendrimers, etc.

As used herein, the term “plurality” refers to two or more, for example, 3 or more, 4 or more, 5 or more, etc.

As used herein, a “reaction” between two reactive groups (such as between a reagent and a particle each including a different reactive group) may mean that a covalent linkage is formed between two reactive groups or two reactive functional groups; or may mean that the two reactive groups or two reactive functional groups associate with each other, interact with each other, hybridize to each other, hydrogen bond with each other, etc. In some embodiments, a “reaction” between two reactive groups includes binding events.

As used herein, the term “reagent” refers to solutions or suspensions including one or more agents capable of covalently or non-covalently reacting with, coupling with, interacting with, or hybridizing to another entity. Non-limiting examples of such agents include specific-binding entities, antibodies (primary antibodies, secondary antibodies, or antibody conjugates), nucleic acid probes, oligonucleotide sequences, detection probes, chemical moieties bearing a reactive functional group or a protected functional group, enzymes, solutions or suspensions of dye or stain molecules.

As used herein, the term “sequence” when used in reference to a nucleic acid, refers to the order of nucleotides (or bases). In cases, where different species of nucleotides are present, the sequence includes an identification of the species of nucleotide (or base) at respective positions in of the nucleic acid or oligonucleotide.

As used herein, the terms “sequencing” or “DNA sequencing” refer to biochemical methods for determining the order of the nucleotide bases, adenine, guanine, cytosine, and thymine, in a DNA oligonucleotide. Sequencing, as the term is used herein, can include without limitation parallel sequencing or any other sequencing method known of those skilled in the art, for example, chain-termination methods, rapid DNA sequencing methods, wandering-spot analysis, Maxam-Gilbert sequencing, dye-terminator sequencing, sequencing by synthesis, nanopore-based sequencing, sequencing by expansion, or using any other modern automated DNA sequencing instruments.

As used herein, the phrase “split-pool synthesis” refers to a combinatorial synthesis process in which a reaction mixture is divided into several different aliquots prior to performing a reaction, and wherein each aliquot receives a different chemical entity to be reacted with, coupled with, introduced via enzymatic polymerization, introduced via annealing of a complementary oligonucleotide to part of the sequence and template-driven polymerization, etc., e.g. a monomer, an oligomer, an assayable polymer subunit, etc. Following the coupling reaction, the aliquots are combined (pooled), mixed, and divided (split) into a new set of aliquots prior to performing the next round of coupling. In general, split-pool synthesis may be applied to any combinatorial synthetic method where it is desired to prepare a large number of compounds in a single process. In some embodiments, the approach may be used for a variety of coupling reactions and conjugation chemistries including, but not limited to, amino acid (or short peptide) coupling reactions to produce longer peptides of fully or partially random amino acid sequences, the coupling of deoxyribonucleotides (or short DNA oligonucleotides) to produce longer DNA oligonucleotides of fully or partially random base sequences, or the coupling of ribonucleotides (or short RNA oligonucleotides) to produce longer RNA oligonucleotides of fully or partially random base sequences, ligation reactions, polymerase chain reactions, click-chemistry coupling reactions, etc. Any of a variety of chemical monomers, e.g., amino acids, small molecules, short peptides, short oligonucleotides, etc., may thus be utilized. In some embodiments, the chemical reagents are metals and the split-pool synthesis is utilized to generate metal alloys combinatorily. In some embodiments, a split-pool synthesis is adapted for split-pool barcoding and/or quantum barcoding, where particles are iteratively reacted with agents, such as monomeric agents, for the generation of statistically unique barcodes.

As used herein, the term “substantially” means the qualitative condition of exhibiting total or near-total extent or degree of a characteristic or property of interest. In some embodiments, “substantially” means within about 5%. In some embodiments, “substantially” means within about 10%. In some embodiments, “substantially” means within about 15%. In some embodiments, “substantially” means within about 20%.

As used herein, the terms “unique binding agent” or “UBAs” refer to molecules or assemblies that are designed to bind with at least one target molecule, at least one target molecule surrogate, or both; and can, under appropriate conditions, form a molecular complex including the UBA and the target molecule. Examples of target molecules include, but are not limited to, proteins, nucleic acids, lipids, carbohydrates, ions, small molecules, organic monomers, and drugs. In some embodiments, the UBAs that bind to a target protein or a target mRNA. The terms “protein,” “polypeptide,” “peptide,” and “amino acid sequence” are used interchangeably herein to refer to polymers of amino acids of any length. In some embodiments, the polymer may be linear or branched, it may comprise modified amino acids, and it may be interrupted by non-amino acids or synthetic amino acids. The terms also encompass an amino acid polymer that has been modified, for example, by disulfide bond formation, glycosylation, lipidation, acetylation, phosphorylation, or any other manipulation, such as conjugation with a labeling component. As used herein the term “amino acid” refers to either natural and/or unnatural or synthetic amino acids, including but not limited to glycine and both the D or L optical isomers, and amino acid analogs and peptidomimetics. In some embodiments, “UBAs” include at least one reaction portion that facilitates their binding to or interaction with at least one target molecule, at least one part of at least one target molecule, at least one target molecule surrogate, at least part of a target molecule surrogate, or combinations thereof; typically in a sequence-specific manner, a confirmation-specific manner, or both (e.g. antigen-antibody binding, aptamer-target binding, and the like). In some embodiments, the UBAs comprise an identity portion or at least part of an identity portion, for example, an ESB, a COB, an ESB and/or a linker oligo. In certain embodiments, the UBAs comprise a capture region. In some embodiments, the capture region is used for the isolation of the UBA and/or immobilization of the UBA into a surface. In some embodiments, the capture region can be an affinity tag, a bead, a slide, an array, a microdroplet, or any other suitable capture region in the art. In some embodiments, the capture region is the ESB, for example the ESB can be a detectable bead such as a bead with a unique spectral signature (e.g. a bead that has been internally dyed with red and infrared fluorophores). Capture regions can define reaction volumes in which manipulation of compositions of the disclosure can take place. UBAs, ESB, and COBs are further described herein and in U.S. Pat. No. 10,144,950, the disclosure of which is hereby incorporated by reference herein in its entirety.

Overview

Applicant has developed a split-pooling apparatus adapted to (i) divide a population of particles into multiple subpopulations; (ii) permit each of the subpopulation of particles to be separately reacted with a different reagent, and (iii) pool the different reacted subpopulations of particles together. In the context of a population of particles, the terms “divide” or “dividing” refer to processes where the population of particles is randomly distributed or where the population of particles is deterministically distributed (e.g. dispersing particles such that particles in one subpopulation are deterministically distinct from particles in other subpopulations). Likewise, in the context of a population of particles, the terms “pool” or “pooling” refer to processes where the subpopulations of particles are randomly or deterministically combined.

In some embodiments, the dividing of the population of particles comprises transferring the particles (e.g. by flowing, partitioning, trapping, or corralling) to different reaction vessels, such that each different reaction vessel includes a different subpopulation of particles. In some embodiments, each subpopulation of particles in each different reaction vessel is reacted with a different reagent, to provide different subpopulations of particles each reacted with a different reagent. Following reaction, in some embodiments the different reacted subpopulations of particles are pooled together in a pooling vessel (e.g. a vessel different than any of the reaction vessels).

In some embodiments, the disclosed split-pooling apparatus is configured to repeat the aforementioned process a predetermined number of times. For example, the process may comprise (i) dividing a population of particles into a plurality of subpopulations (ii) permitting each subpopulation of particles of the plurality of subpopulations of particles to be separately reacted with a different reagent, such as in one of a plurality of reaction vessels, to provide a plurality of different reacted subpopulations of particles; and (iii) pooling each of the plurality of different reacted subpopulations of particles together; and (iv) again dividing the particles such that the process may be iterated for subsequent split-pooling steps. In some embodiments, the aforementioned process may be repeated without (i) considerable loss of material, (ii) contamination from an outside environment, and/or (iii) damage to the particles themselves.

In some embodiments, repeated cycling of the aforementioned process allows each of the particles to be randomly or deterministically reacted with a different reagent each time the process is repeated. In some embodiments, each time the process is repeated a different oligonucleotide sequence or assayable polymer subunits may be appended to the particle so as to provide a population of particles (such as after all the predetermined number of reactions have been carried out) each having a statistically unique concatemeric nucleotide sequence or a statistically unique sequence of assayable polymer subunits. In some embodiments, the process is repeated until each of the particles in the population includes a moiety which is statistically different, e.g. a different concatemeric nucleotide sequence. These and other embodiments will be described herein.

In some embodiments, the disclosed split-pooling apparatus, methods, and/or kits facilitate the detection and quantification of individual target molecules in biological samples. In some embodiments, the split-pooling apparatus and methods described herein enable detection and quantification of one or more target molecules in individual cells or sub-cellular units (including macromolecular complexes) present in the sample, where the sample comprises a large population of cells or a mixture of multiple sub-cellular units of macromolecular complexes.

In some embodiments, the split-pooling apparatus disclosed herein facilitates implementation of the quantum barcoding (QBC) protocol described in the U.S. Pat. Nos. 10,144,950, and 10,174,310, and in U.S. patent application Ser. Nos. 15/525,876, 16/518,794 and 16/163,486 the disclosures of which are hereby incorporated by reference herein in their entireties. Briefly, the QBC protocol comprises the use of unique binding agents (UBA) to bind each of the target molecules, the use of epitope-specific barcodes (ESB) optionally attached to and identifying the UBAs, and assembling cell-originating barcodes (COB) on the UBAs (and optionally ESBs) such that each of the variety of target molecules present in the cell is labeled with the same unique barcode particular to that cell. The method of assembling cell-originating barcodes (COB) involves a split-pool synthesis step, such as described herein. As described above, using the most basic calculation, if a different sub-code is present in each container or well, after M rounds of splitting the population of particles into N wells, N^{M} different codes will be assembled from sub-codes. For example, 3 rounds of splitting into 96-well plates, can generate about 10⁶ unique barcodes, enough to individually label each particle in a typical volume of a sample.

In some embodiments, the split-pooling apparatus 100 disclosed herein may be used to implement any of the processes described in the following references: A. M. Klein, L. Mazutis, I. Akartuna, N. Tallapragada, A. Veres, V. Li, et al. “Droplet Barcoding for Single-Cell Transcriptomics Applied to Embryonic Stem Cells,” Cell, Vol. 161, 1187-201, 20151; C. Trapnell, “Defining Cell Types and States with Single-Cell Genomics,” Genome Res., Vol 25, 1491-1498, 2015; V. Svensson, K. N. Natarajan, L.-H. Ly, R. J. Miragaia, C. Labalette, I. C. Macaulay, et al. “Power Analysis of Single-Cell RNA-Sequencing Experiments,” Nat. Methods, Vol. 14, 381-387, 2017; E. Z. Macosko, A. Basu, R. Satija, J. Nemesh, K. Shekhar, M. Goldman, et al. “Highly Parallel Genome-Wide Expression Profiling of Individual Cells Using Nanoliter Droplets”, Cell, Vol. 161, 1202-1214, 2015; A. B. Rosenberg, C. M. Roco, R. A. Muscat, A. Kuchina, P. Sample, Z. Yao, L. T. Graybuck, D. J. Peeler, S. Mukherjee, W. Chen, S. H. Pun, D. L. Sellers, B. Tasic, G. Seelig, “Single-Cell Profiling of the Developing Mouse Brain and Spinal Cord with Split-Pool Barcoding”, Science, Vol. 360, 176-182, 2018; T. M. Gierahn, M. H. Wadsworth II, T. K. Hughes, B. D. Bryson, A. Butler, R. Satija, S. Fortune, J. C. Love, and A. K. Shalek, “Seq-Well: Portable, Low-Cost RNA Sequencing of Single Cells at High Throughput”, Nat. Methods, Vol. 14, 395-398, 2017, the disclosures of each are hereby incorporated by reference herein in their entireties.

Split-Pooling Appartus

In one aspect of the present disclosure is a split-pooling apparatus 100 which may be utilized to facilitate any number of chemical reactions and also may be used for organic and inorganic chemical synthesis. In some embodiments, the split-pooling apparatus 100 may be utilized for labeling particles. In some embodiments, the split-pooling apparatus 100 is configured to facilitate split-pool synthesis, e.g. split-pool barcoding and/or quantum barcoding. In some embodiments, the split-pooling apparatus 100 of the present disclosure facilitates the quantum barcoding processes described herein and those set forth in U.S. Pat. Nos. 10,144,950, and 10,174,310, and in U.S. patent application Ser. Nos. 15/525,876, 16/518,794 and 16/163,486, the disclosures of which are hereby incorporated by reference herein in their entireties. With reference to FIG. 2, in one aspect of the present disclosure is a split-pooling apparatus 100 which includes a fluidics module 402, a control system 401, and a split-pooling array 400. In some embodiments, the split-pooling array 400 includes or may be adapted to include (such as in real time or in an on-demand manner) a plurality of reaction vessels, as described herein. In some embodiments, each of the split-pooling arrays of the present disclosure may be used interchangeably within a split-pooling apparatus 100. In other embodiments, the split-pooling apparatus of the present disclosure may include two or more different split-pooling arrays. As such, in some embodiments, different split-pooling arrays 400 may be used in conjunction with each other in any split-pooling apparatus.

In some embodiments, the fluidics module 402 includes one or more dispensers adapted to introduce fluids, reagents, particles, etc. to a split-pooling array 400 (e.g. to a pooling vessel or to one or more reaction vessels of the split-pooling array 400). In some embodiments, the fluidics module 402 further includes one or more reservoirs 403 for storing fluids, reagents, and/or particles (e.g. reagent reservoirs, particle collection reservoirs, particle storage reservoirs, and/or waste collection reservoirs). In some embodiments, the fluidics module 402 includes one or more pumps. In some embodiments, the one or more pumps are in fluidic communication with the one or more dispensers and/or the one or more reservoirs so as to facilitate the transfer and/or the dispensing of the fluids, reagents, and/or particles from the one or more reservoirs and to and/or from the split-pooling array 400 (e.g. from the pooling vessel or the plurality of reaction vessels of the split-pooling array 400). In other embodiments, a solids dispenser is utilized to introduce one or more solid reagents, pellets, etc. to one or more pooling vessels and/or one or more reaction vessels.

In some embodiments, the split-pooling apparatus 100 is communicatively coupled to one or more sensors (temperature sensors, pressure sensors, proximity sensors, humidity sensors, and/or fluid flow rate sensors) and/or feedback control modules. In some embodiments, the split-pooling apparatus 100 or any component thereof is in communication with one or more heating and/or cooling modules. In some embodiments, the control module 401 is communicatively coupled to the one or more sensors, feedback control modules, and/or the one or more heating and/or cooling modules.

Each of these components and other components of a split-pooling apparatus 100 are described herein.

Split-Pooling Arrays

The present disclosure provides three different types of split-pooling arrays. While each split-pooling array has a different configuration, they each include or may be configured to include a plurality of reaction vessels to facilitate split-pooling synthesis. In some embodiments a split-pooling array may include or be configured to include 4 reaction vessels, 8 reaction vessels, 12 reaction vessels, 16 reaction vessels, 20 reaction vessels, 24 reaction vessels, 28 reaction vessels, 32 reaction vessels, 36 reaction vessels, 40 reaction vessels, 44 reaction vessels, 48 reaction vessels, 52 reaction vessels, 56 reaction vessels, 60 reaction vessels, 64 reaction vessels, 68 reaction vessels, 72 reaction vessels, 76 reaction vessels, 80 reaction vessels, 84 reaction vessels, 88 reaction vessels, 92 reaction vessels, 96 reaction vessels, 100 reaction vessels, 104 reaction vessels, 108 reaction vessels, 112 reaction vessels, 116 reaction vessels, 120 reaction vessels, 124 reaction vessels, 128 reaction vessels, etc.

In some embodiments, the reactions vessels are channels. In some embodiments, the split-pooling array 400 includes a plurality of channels, e.g. between about 4 and about 128 channels. In some embodiments, the reactions vessels are tubes. In some embodiments, the split-pooling array 400 includes a plurality of tubes, e.g. between about 4 and about 128 tubes. In some embodiments, the reactions vessels are capillary channels. In some embodiments, the split-pooling array 400 includes a plurality of capillary channels, e.g. between about 4 and about 128 capillary channels. In some embodiments, each channel is independently operable. In some embodiments, each channel is bundled together in a housing.

In some embodiments, the reaction vessels are formed compartments, e.g. compartments formed by segmenting a single pooling vessel into two or more reaction vessels. In some embodiments, the compartments are formed on the surface of an elastomeric sheet. In some embodiments, a split-pooling array 400 includes a plurality of compartments formed on the surface of an elastomeric sheet, e.g. between 4 and about 128 compartments formed on the surface of the elastomeric sheet. In other embodiments, the compartments are formed within a tray. In some embodiments, the split-pooling apparatus 400 includes a plurality of compartments formed within a tray, e.g. between about 4 and about 128 compartments formed within the tray. Methods of forming the plurality of compartments are described herein.

Channel-Based Split-Pooling Array

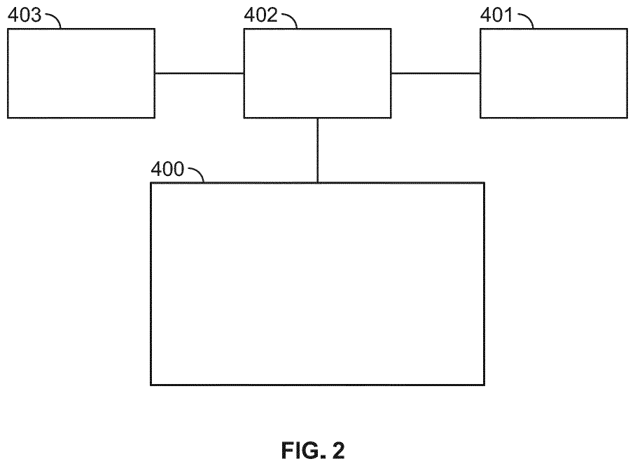

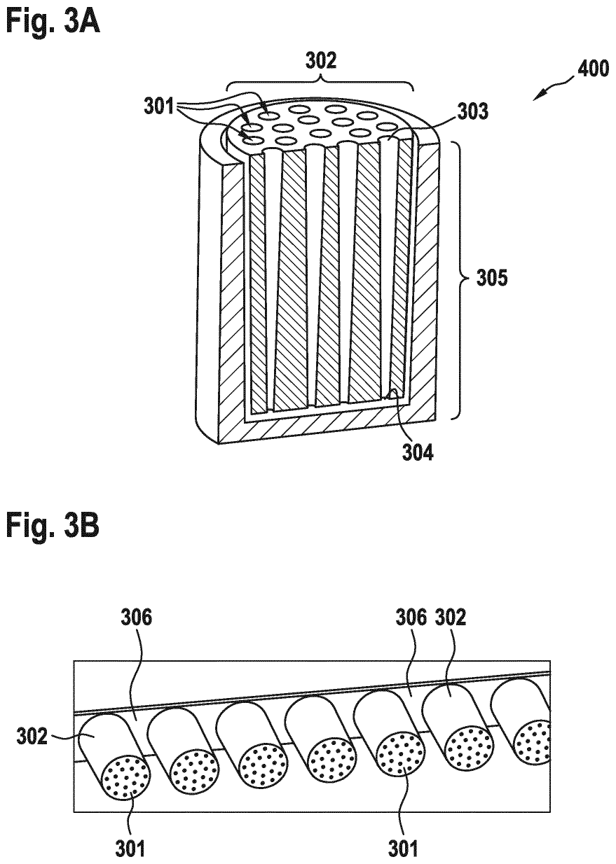

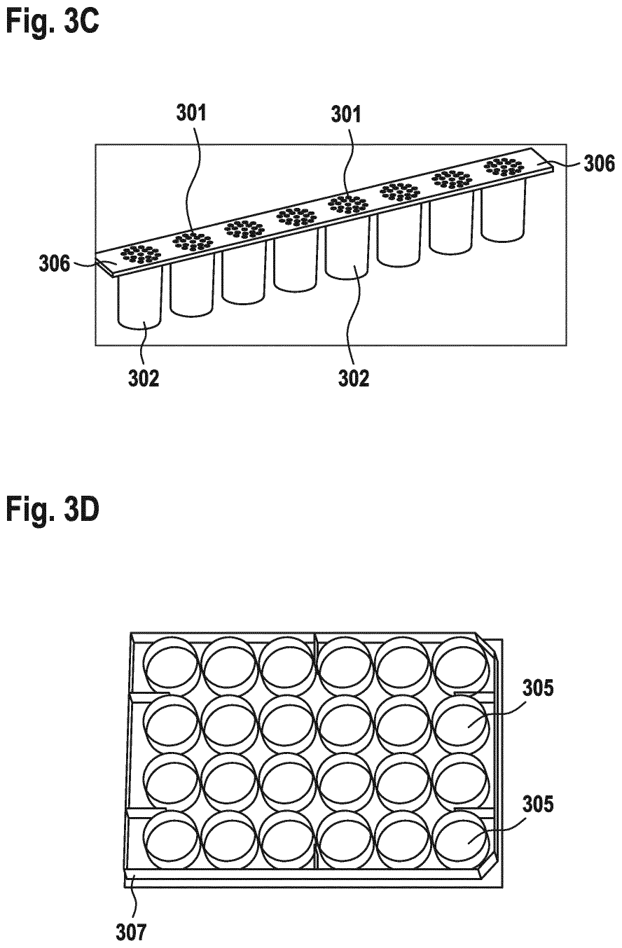

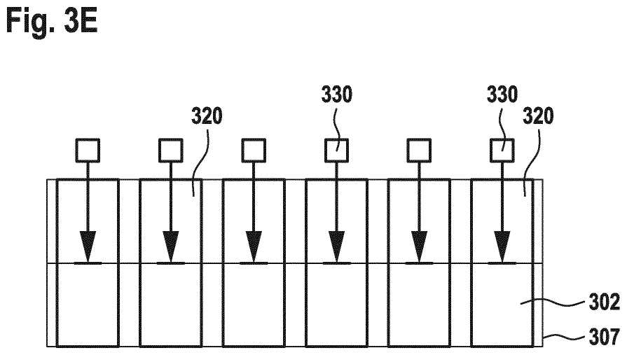

With references to FIGS. 3A-3D, in some embodiments, the channel-based split-pooling array 400 comprises a plurality of channels 301 housed within a nib 302. In some embodiments, each of the plurality of the channels 301 serve as an independent reaction vessel for conducting split-pool synthesis. In some embodiments, the nib 302 includes between 4 and about 128 channels 301, each of which are independently operable. In other embodiments, the nib 302 includes between 4 and about 96 channels 301. In other embodiments, the nib 302 includes between 4 and about 64 channels 301. In other embodiments, the nib 302 includes between 4 and about 32 channels 301. In other embodiments, the nib 302 includes between 8 and about 16 channels 301. In some embodiments, each of the channels serve as an independent reaction vessel where one or more chemical reactions may take place. In some embodiments, the quantum barcoding processes described herein and set forth in U.S. Pat. Nos. 10,144,950, and 10,174,310, and in U.S. patent application Ser. Nos. 15/525,876, 16/518,794 and 16/163,486 (the disclosures of which are hereby incorporated by reference herein in their entireties) may take place in each of the plurality of the channels. In some embodiments, the channels are tubes. In other embodiments, the channels are capillary channels.

In some embodiments, each channel 301 has a first opening 303 located at a first end and a second opening 304 located at a second end. In some embodiments, each of the first and second openings 303 and 304, respectively, allow for fluids, reagents, particles, a gas, and/or a vacuum to be introduced into or drawn from the channels 301. In some embodiments, each channel 301 comprises a taper. For instance, each channel 301 may taper from a first end to a second end such that a first opening 303 at the first end is larger than a second opening 304 at the second end. In some embodiments, the tapered channels are tapered tubes. In other embodiments, the tapered channels are tapered capillary channels.

In some embodiments, each channel 301 has a volume ranging from between about 0.5 μL to about 10 mL. In some embodiments, each channel 301 has a volume ranging from between about 1 μL to about 1 mL. In some embodiments, each channel 301 has a volume ranging from between about 1 μL to about 500 μL. In some embodiments, each channel 301 has a volume ranging from between about 1 μL to about 250 μL. In some embodiments, each channel 301 has a volume ranging from between about 1 μL to about 100 μL. In some embodiments, each channel 301 has a volume ranging from between about 1 μL to about 50 μL. In some embodiments, each channel 301 has a volume ranging from between about 1 μL to about 10 μL. In some embodiments, each channel 301 has a volume ranging from between about 1 μL to about 5 μL. In other embodiments, each channel has a volume ranging from between about 2 μL to about 3 μL.

In some embodiments, the channel-based split-pooling array 400 further includes a well 305. In some embodiments, the nib 305 and the well 302 have complementary sizes and/or shapes such that the nib 302 at least partially fits within the well 305. For instance, if the nib 302 has a circular shape, then the well 305 would have a complementary circular shape, provided that the nib 302 at least partially fits within the well 305. Likewise, if the nib 302 has a rectangular shape, then the well 305 would have a complementary rectangular shape, provided that the nib 302 at least partially fits within the well 305.

In some embodiments, the well 305 has a volume ranging from between about 1 μL to about 15 mL. In some embodiments, the well 305 has a volume ranging from between about 1 μL to about 10 mL. In some embodiments, the well 305 has a volume ranging from between about 1 μL to about 1 mL. In some embodiments, the well 305 has a volume ranging from between about 10 μL to about 500 μL. In some embodiments, the well 305 has a volume ranging from between about 30 μL to about 400 μL. In other embodiments, the well 305 has a volume ranging from between about 50 μL to about 200 μL. In yet other embodiments, the well 305 has a volume ranging from between about 100 μL to about 150 μL.

In some embodiments, two or more nibs 302 may be integrated within a nib assembly 306. In some embodiments, the nib assembly 306 includes between 2 and about 16 nibs 302. In other embodiments, the nib assembly 306 includes between 2 and about 12 nibs 302. In other embodiments, the nib assembly 306 includes between 4 and about 12 nibs 302. In other embodiments, the nib assembly 306 includes between 4 and about 8 nibs 302. In some embodiments, the nib assembly 306 comprises a single row of nibs 302.

In other embodiments, the nib assembly 306 includes multiple rows of nibs 302, e.g. between 2 and about 8 rows of nibs, between 2 and about 6 rows of nibs, or between 2 and about 4 rows of nibs. In this manner, the nib assembly 306 may have a grid pattern. In some embodiments grid may be a 3×2 grid, a 3×3 grid, a3×4 grid, a 3×5 grid, a 3×6 grid, a 3×7 grid, a 3×8 grid, etc. In some embodiments, the grid may be a 4×2 grid, a 4×3 grid, a 4×4 grid, a 4×5 grid, a 4×6 grid, a 4×7 grid, a 4×8 grid, etc. In some embodiments, the number, arrangement, and/or sizes of the nibs 302 within a nib assembly 306 may be complementary to a plate 307 having a plurality of wells 305, as described below.

In some embodiments, the channel-based split-pooling array 400 includes a plate 307 having a plurality of wells 305. In some embodiments, the plate 307 comprises between 4 and about 128 wells 305. In some embodiments, the plate 307 comprises between 8 and about 96 wells 305. In some embodiments, the plate 307 comprises between 8 and about 64 wells 305. In some embodiments, each well serves as a pooling vessel.

In some embodiments, each nib is independently in fluidic communication with a manifold, where the manifold may, in turn, be in fluidic communication with a vacuum source and/or a gas source (e.g. an inert gas source). In some embodiments, the manifold may include one or more ports, valves, and/or one or more sensors coupled to control system 401. In this manner, a vacuum may be drawn through the manifold such that fluids, reagents, particles, etc. may be drawn into and/or through each of the channels 301 within a nib 302. Likewise, a gas may be fed through the manifold such that fluids, reagents, particles, etc. contained within each of the channels 301 within nib 302 (such as after the completion of a reaction) may be expelled from each channel 301. As such, fluids, reagents, particles, may be repeatedly drawn into or expelled from the channels.

In some embodiments, the channel-based split pooling array 400 includes a loading device 320 having a plurality of loading channels. In some embodiments, the loading device 320 and/or the loading channels of the loading device 320 include features (e.g. size, shape, etc.) which are complementary to a nib 302 and/or the channels 301 within the nib 302. In some embodiments, each of the loading channels of the loading device 320 have an opening which is complementary in size (e.g. diameter) and shape (e.g. substantially circular) to an opening in one of the channels 301 of nib 302. For example, if a nib 302 comprise 16 channels 301, then the loading device 320 would include 16 loading channels each having an opening having a size and shape complementary to one of the channels 301 of nib 302. Likewise, the arrangement and/or positions of the 16 loading channels in the loading device 320 would correspond to and be complementary to the arrangements and/or positions of the 16 channels 301 in the nib 302. In some embodiments, the complementary loading channels are adapted to fit within the channels 301 of nib 302. In other embodiments, the channels 301 of nib 302 are configured to fit within the complementary loading channels of loading device 320.

As described further herein, the loading channels of loading device 320 may be pre-loaded with one or more fluids, reagents, and/or particles. In those embodiments where the loading channels of loading device 320 are pre-loaded with one or more fluids, reagents, and/or particles, when the loading device 320 is placed in contact with the nib 302, the reagents may flow (e.g. by capillary action) from the loading channels to the channels 301 of nib 302. In some embodiments, the loading channels of the loading device 320 may be pre-loaded within one or more reagents and those reagents may be transferred to the respective channels 301 of nib 302 by (i) placing the loading device 320 and the nib 302 in fluidic communication with each other such that the channels 301 of the nib 302 align with the loading channels of the loading device; and (ii) injecting the reagents into the channels 301 of nib 302 with an injector mechanism 330, e.g. a plunger, a pin, etc. In some embodiments, the loading channels of each loading device are preloaded with liquid reagents. In some embodiments, the loading channels of each loading device 320 are preloaded with solid reagents.

In other embodiments, the loading channels of the loading device have smaller size openings (e.g. diameters) as compared with the channels 301 of nib 302. In these embodiments, the loading channels are capable of insertion within the channels 301 of nib 302 such that any reagents (liquid or solid) may be transferred from the loading channels to the channels 301 (e.g. by flowing liquid reagents, by pressurizing the loading channels such that liquid or solid reagents are transferred). In some embodiments, the loading devices are fluidically coupled to a vacuum source. In some embodiments, the loading devices are coupled to a movable subassembly or movable by robotic handler.

Virtual Compartment-Based Split-Pooling Array

In some embodiments, the split-pooling array comprises a plurality of “virtual compartments” that are formed in real-time and/or on-demand from an elastomeric sheet. In some embodiments, the plurality of compartments are formed by applying one or more forces to a plurality of predetermined regions of the elastomeric sheet as described herein. In this regard, the elastomeric sheet serves as both a pooling vessel (such as when no forces are applied to it) and as the plurality of reaction vessels (such as after forces are applied to it). For instance, prior to the application of the one or more forces to the plurality of predetermined areas, the elastomeric sheet may serve as a pooling vessel and may have a planar surface or a slightly concave surface. Following the application of the one or more forces to the plurality of predetermined regions, a plurality of concave areas may be formed within the elastomeric sheet, where each of the concave areas (i.e. formed compartments) may serve as a plurality of reaction vessels. As described herein, the elastomeric sheet may be repeatedly configured from at least a first conformation which serves as the pooling vessel and to at least a second configuration which serves as the plurality of reaction vessels. In some embodiments, the quantum barcoding process described herein and set forth in U.S. Pat. No. 10,144,950 may take place in each of the plurality of formed compartments.

In some embodiments, the “virtual compartment” split-pooling array 400 may be configured to include 4 reaction vessels, 8 reaction vessels, 12 reaction vessels, 16 reaction vessels, 20 reaction vessels, 24 reaction vessels, 28 reaction vessels, 32 reaction vessels, 36 reaction vessels, 40 reaction vessels, 44 reaction vessels, 48 reaction vessels, 52 reaction vessels, 56 reaction vessels, 60 reaction vessels, 64 reaction vessels, 68 reaction vessels, 72 reaction vessels, 76 reaction vessels, 80 reaction vessels, 84 reaction vessels, 88 reaction vessels, 92 reaction vessels, 96 reaction vessels, 100 reaction vessels, 104 reaction vessels, 108 reaction vessels, 112 reaction vessels, 116 reaction vessels, 120 reaction vessels, 124 reaction vessels, 128 reaction vessels, etc.

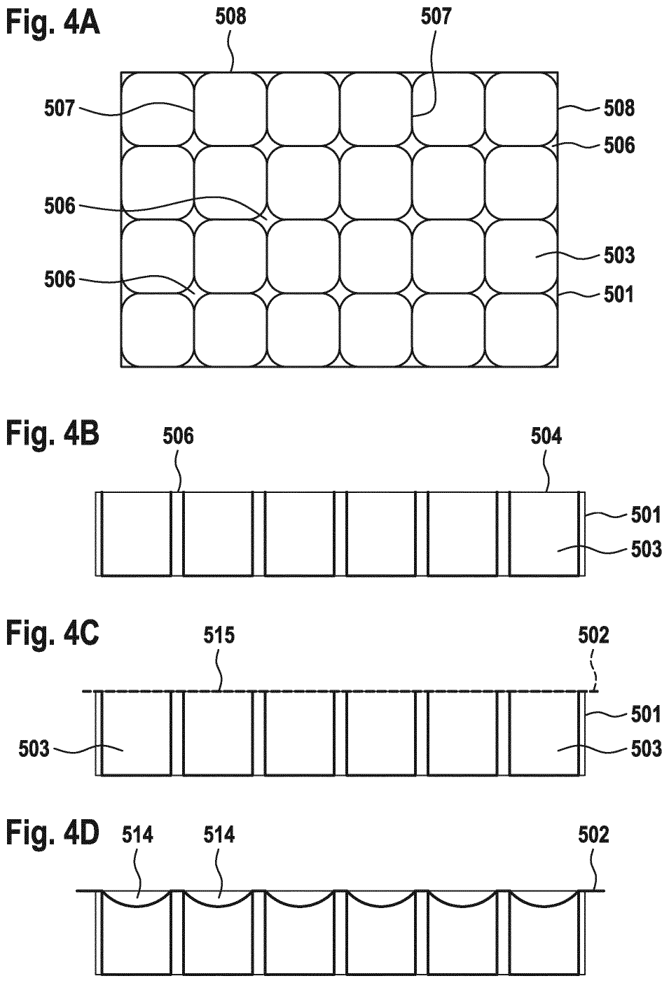

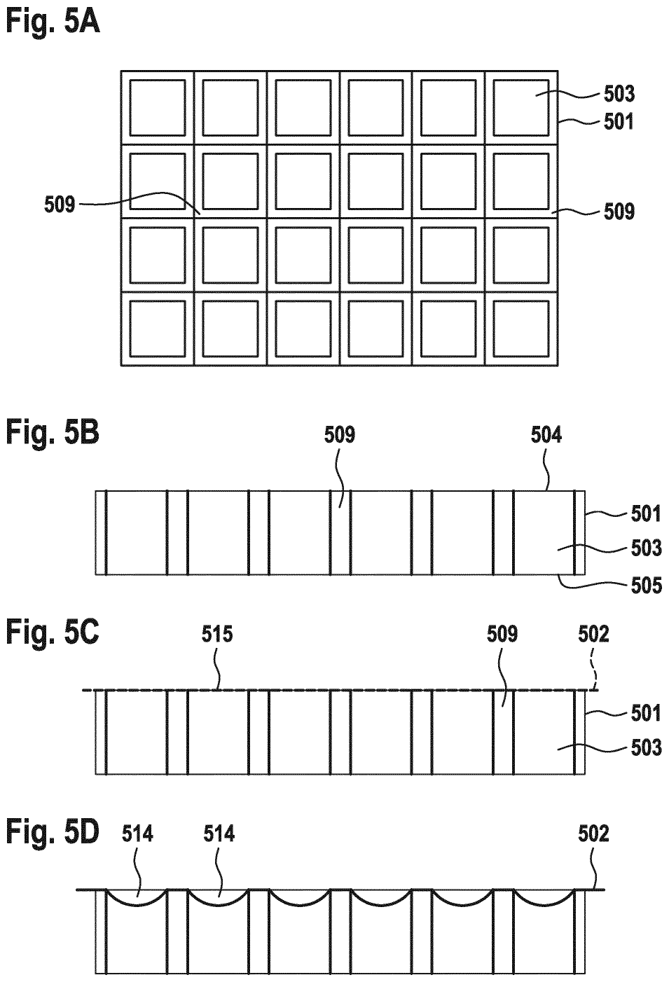

With reference to FIGS. 4A-4D and 5A-5D, in some embodiments, the virtual compartment-based split-pooling array 400 comprises a plate 501 and an elastomeric sheet 502. In some embodiments, the plate 501 may have any size or shape. In some embodiments, the plate 501 is substantially circular. In other embodiments, the plate 501 is substantially ovoid. In yet other embodiments, the plate 501 is rectangular.

In some embodiments, the plate 501 includes a plurality of depressions 503. Each depression of the plurality of depressions may have any size or shape. In some embodiments, each depression of the plurality of depressions is the same. In other embodiments, some of the depressions are the same while others are different. In some embodiments, the depressions 503 are substantially circular. In other embodiments, the depressions 503 are substantially ovoid. In yet other embodiments, the depressions 503 are rectangular. In yet other embodiments, the depressions 503 have a complex shape. In some embodiments, each depression has a volume which is at least sufficient to permit the material of the elastomeric sheet to be pushed into or pulled into the depression, such as described herein. In some embodiments, each depression 503 has a volume ranging from between about 0.5 μL to about 10 mL. In some embodiments, each depression 503 has a volume ranging from between about 1 μL to about 1 mL. In some embodiments, each depression 503 has a volume ranging from between about 1 μL to about 500 μL.

In some embodiments, the plate 501 includes between 4 and 128 depressions 503. In some embodiments, the plate 501 includes between 4 and 96 depressions 503. In other embodiments, the plate 501 includes between 4 and 64 depressions 503. In other embodiments, the plate 501 includes between 4 and 32 depressions 503. In other embodiments, the plate 501 includes between 4 and 24 depressions 503. In other embodiments, the plate 501 includes between 4 and 12 depressions 503.

In some embodiments, the depressions 503 of plate 501 may be arranged in a grid. For example, the grid may be a 2×2 grid, a 2×3 grid, a 24 grid, a 2×5 grid, a 2×6 grid, a 2×7 grid, a 2×8 grid, a 2×9 grid, a 2×10 grid, a 2×11 grid, a 2×12 grid, etc. In some embodiments grid may be a 3×2 grid, a 3×3 grid, a 3×4 grid, a 3×5 grid, a 3×6 grid, a 3×7 grid, a 3×8 grid, a 3×9 grid, a 3×10 grid, a 3×11 grid, a 3×12 grid, etc. In some embodiments, the grid may be a 4×2 grid, a 4×3 grid, a 4×4 grid, a 4×5 grid, a 4×6 grid, a 4×7 grid, a 4×8 grid, a 4×9 grid, a 4×10 grid, a 4×11 grid, a 4×12 grid, etc. In some embodiments, the grid may be a 5×2 grid, a 5×3 grid, a 5×4 grid, a 5×5 grid, a 5×6 grid, a 5×7 grid, a 5×8 grid, a 5×9 grid, a 5×10 grid, a 5×11 grid, a 5×12 grid, etc. In some embodiments, the grid may be a 6×2 grid, a 6×3 grid, a 6×4 grid, a 6×5 grid, a 6×6 grid, a 6×7 grid, a 6×8 grid, etc. In some embodiments, the grid may be a 7×2 grid, a 7×3 grid, a 7×4 grid, a 7×5 grid, a 7×6 grid, a 7×7 grid, a 7×8 grid, etc. In some embodiments, the grid may be a 4×2 grid, a 8×3 grid, a 8×4 grid, a 8×5 grid, a 8×6 grid, a 8×7 grid, a 8×8 grid, etc. In some embodiments, the formed compartments will assume the layout of the grid of depressions, but not necessarily the shape of the depressions.

In some embodiments, the depressions 503 have one opening 504, such as depicted in FIG. 4B. In other embodiments, the depressions 503 have two openings 504 and 505, such as depicted in FIG. 5B. In some embodiments, a first opening 504 may have a first size and/or shape, and a second opening 505 may have a second size and/or shape. In some embodiments, the first opening 504 is larger than the second opening 505.

In some embodiments, the depressions 503 may each be independently in fluidic communication with a vacuum source. In some embodiments, each second opening 505 is independently in fluidic communication with a different vacuum source. In other embodiments, each second opening 505 is in fluidic communication with a universal vacuum source.

In some embodiments, the vacuum source may include a manifold having one or more valves and which may be fluidly coupled to a pressurization source via a fluid line. In some embodiments, the manifold can be configured to draw a vacuum through a vacuum port located within a second opening 505 of a depression 503 via a fluid line. In some embodiments, the vacuum source may also include a pressure sensor such that the control system 401 may command the vacuum source to stop drawing the vacuum once a predetermined pressure is detected.

As noted above, the “virtual compartment” split-pooling array further includes an elastomeric sheet 502 which is configured to be placed on top of the plate 501. In some embodiments, the elastomeric sheet 502 is supported by one or more staves 506 which are contiguous with the plate 501 or the depressions 503. In some embodiments, the elastomeric sheet 502 is supported by the tops 507 of the depressions themselves and/or by one or more edges 508 of the plate 501.

In some embodiments, the elastomeric sheet 502 is planar when placed on top of the plate 501. In other embodiments, the elastomeric sheet 502 has a concavity when placed on the top of the plate 501. In some embodiments, the elastomeric sheet 502 may be releasably attached to the sides of the plate 501, e.g. releasably attached to all four sides of the plate. In other embodiments, the elastomeric sheet 502 may be fixed to one or more sides of the plate 501, e.g. fixed to all four sides of the plate. In some embodiments, the elastomeric sheet 502 may be taut when coupled to the one or more sides of the plate 501. In other embodiments, the elastomeric sheet may be in a relaxed conformation when attached to the one or more sides of the plate 501, such that the elastomeric sheet 502 has a single concavity.

In some embodiments, the elastomeric sheet 502 has a Young's modulus of less than 6 MPa. In other embodiments, the elastomeric sheet 502 has a Young's modulus of less than 5 MPa. In some embodiments, the elastomeric sheet 502 has a Young's modulus of less than 4 MPa. In some embodiments, the elastomeric sheet 502 has a Young's modulus of less than 3 MPa. In some embodiments, the elastomeric sheet 502 has a Young's modulus of less than 2 MPa. In some embodiments, the elastomeric sheet 502 has a Young's modulus of less than 1.5 MPa. In some embodiments, the elastomeric sheet 502 has a Young's modulus of less than 1 MPa. In some embodiments, the elastomeric sheet 502 has a Young's modulus of less than 0.75 MPa. In some embodiments, the elastomeric sheet 502 has a Young's modulus of less than 0.5 MPa. In some embodiments, the elastomeric sheet 502 has a Young's modulus of less than 0.25 MPa.

In some embodiments, the elastomeric sheet 502 is comprised of a material selected from a silicone, a latex, a natural rubber, a synthetic rubber, a nitrile, a polyethylene terephthalate, a polyurethane, a flexible polyvinyl chloride, a styrene-ethylene-butylene-styrene, or an ethylene vinyl acetate or a blend or mixture thereof. In some embodiments, the elastomeric sheet 502 may be reinforced with fibers. In some embodiments, the elastomeric sheet 502 may be reinforced in predetermined locations to ensure that the elastomeric sheet 502 does not rupture when the “virtual compartments” are repeatedly formed. In other embodiments, the elastomeric sheet 502 may be reinforced in locations which correspond to the locations of one or more troughs 509, described below.

With reference to FIG. 5A, in some embodiments the plate may include a plurality of troughs 509. In some embodiments, the plurality of troughs 509 circumscribe a depression 503. In some embodiments, the elastomeric sheet 502, when placed on top of the plate 501, covers the plurality of troughs 509. In other embodiments, the plate may include a plurality of indentations, such as indentations adapted to receive a protuberance, as described herein.

In some embodiments, the “virtual compartment” split-pooling array 400 includes one or more force generating members (e.g. movable grates and movable elements, both described herein). In some embodiments, the force generating members are adapted to contact the elastomeric sheet at predetermined positions and with predetermined amounts of force. In this manner, the force generating members may temporarily deform the elastomeric sheet in a predetermined manner such that compartments are formed on the surface of the elastomeric sheet, and where each formed compartment serves as a reaction vessel. In some embodiments, the force generating member is coupled to a motor, an actuator, a cam, etc.

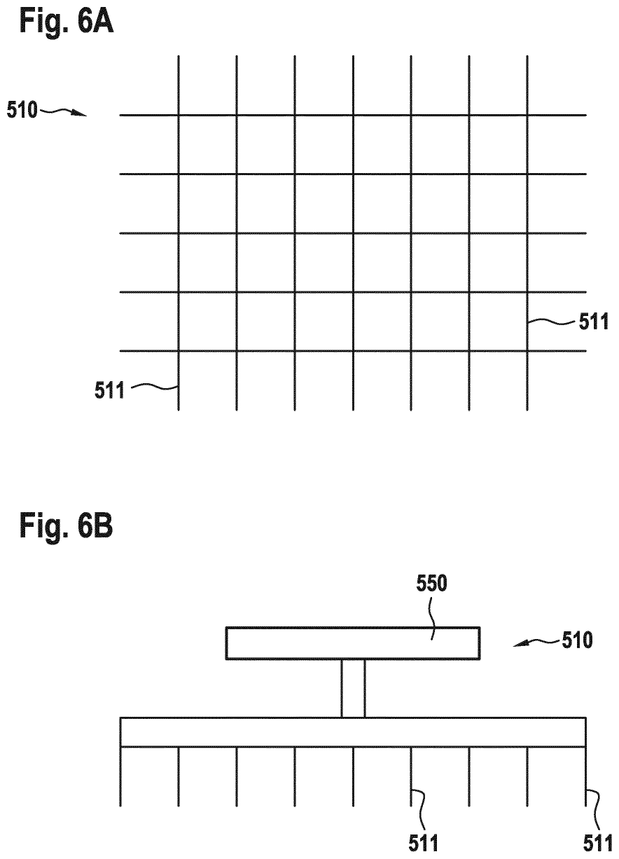

With reference to FIGS. 6A and 6B, in some embodiments, the “virtual compartment” split-pooling array 400 includes one or more movable grates 510. In some embodiments, the one or more movable grates 510 includes a plurality of elements 511 that are complementary to and fit within the plurality of troughs 509 of the plate 501. For instance, if the plate 501 comprises a 4×4 grid of depressions, and each depression is circumscribed by a trough 509, then the movable grate 510 would include a complementary 4×4 grid adapted to fit within the troughs 509. In some embodiments, the movable grate 510 is comprised of a metal, a polymer, or a copolymer.

In some embodiments, a motor, an actuator, a cam, etc. (collectively represented by “550” in FIG. 6B) of the split-pooling apparatus 100 moves the movable grate 510 from a first position above the plate 501, through a second position where each section of the movable grate is in at least partial communication with the surface of the elastomeric sheet 502, and to a third position where each section of the movable grate is in indirect communication with at least a portion of a trough 509. In some embodiments, when the movable grate is in the third position, the movable grate is in at least partial contact with elastomeric sheet; and the elastomeric sheet is in at least partial contact with a top surface of a bottom portion of a trough. In some embodiments, the movement of the movable grate 510 from the second position to the third position causes a predetermined force to be applied to the elastomeric sheet 502 at each of a plurality of predetermined regions (e.g. regions defined by the troughs 509 and/or the depressions 503). In this manner, the application of the predetermined forces facilitates the formation of a plurality of compartments (i.e. the formation of a plurality of reaction vessels 514 from a single pooling vessel 515). In some embodiments, the each of the plurality of formed compartments are temporary concave areas developed within the elastomeric sheet 502, such as on the surface of the elastomeric sheet. In some embodiments, each formed compartment has a volume ranging from between about 0.5 μL to about 10 mL. In some embodiments, each formed compartment has a volume ranging from between about 0.5 μL to about In some embodiments, each formed compartment has a volume ranging from between about 0.5 μL to about 1 mL. In some embodiments, each formed compartment has a volume ranging from between about 1 μL to about 500 μL. In some embodiments, each formed compartment has a volume ranging from between about 1 μL to about 250 μL.

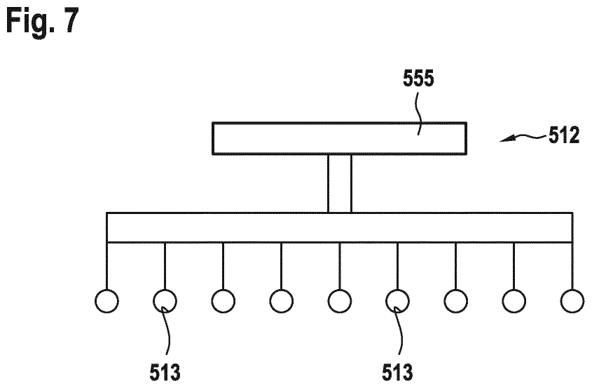

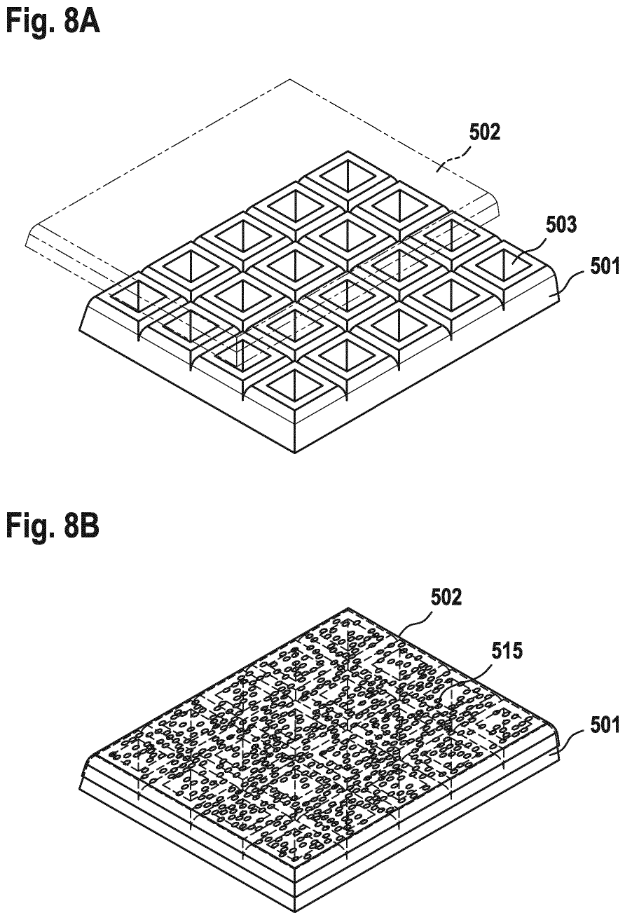

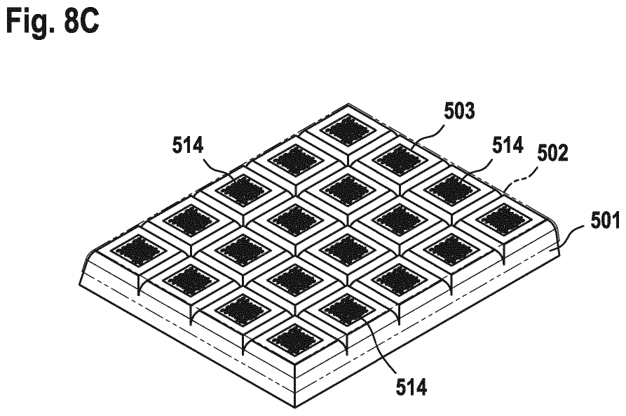

With reference to FIG. 7, in other embodiments, the “virtual compartment” split-pooling array 400 includes one or more movable elements 512 having a plurality protuberances 513 emanating therefrom. In some embodiments, the plurality of protuberances 513 of the movable element 512 are each configured to contact a predetermined location of plate 501 and/or an elastomeric sheet 502 disposed thereon. In some embodiments, the predetermined locations are areas within the plurality of troughs 509 (e.g. each of the corners of each of the troughs) or indentations surrounding the depressions and capable of receiving the protuberances. In some embodiments, the plurality of protuberances 513 are arranged such when placed in contact with the elastomeric sheet 502, the protuberances 513 apply one or more forces substantially equally to predetermined regions of the elastomeric sheet 502. In some embodiments, the application of the one or more predetermined forces stretches the elastomeric sheet 502 in predetermined regions such that a plurality of concave areas are developed within the elastomeric sheet 502. In some embodiments, each protuberance 513 is comprised of a metal, a polymer, or a copolymer.

In some embodiments, a motor, an actuator, a cam, etc. (collectively represented by “555” in FIG. 7) of the split-pooling apparatus 100 moves the movable element 512 from a first position above the plate 501, through a second position where each protuberance 513 of the movable element 512 is in communication with a predetermined location of the elastomeric sheet 502, and to a third position where each protuberance 513 of the movable element 512 is in communication with a portion of a trough 509 or other feature (e.g. an indentation). In some embodiments, the movement of the movable element 512 from the second position to the third position causes a predetermined force to be applied to the elastomeric sheet 502 at each of a plurality of predetermined positions as each of the protuberances 513 contact the elastomeric sheet 502. In this manner, the application of the predetermined forces facilitates the formation of a plurality of compartments 514. In some embodiments, the each of the plurality of formed compartments 514 are temporary concave areas developed within the elastomeric sheet (i.e. a plurality of reaction vessels 514 are formed from a single pooling vessel 515). In some embodiments, each formed compartment has a volume ranging from between about 0.5 μL to about 10 mL. In some embodiments, each formed compartment has a volume ranging from between about 0.5 μL to about In some embodiments, each formed compartment has a volume ranging from between about 0.5 μL to about 1 mL. In some embodiments, each formed compartment has a volume ranging from between about 1 μL to about 500 μL. In some embodiments, each formed compartment has a volume ranging from between about 1 μL to about 250 μL.

Partitionable Split-Pooling Array

In some embodiments, the partitionable split pooling array 400 comprises a plurality of compartments 614 that are formed in real-time and/or on-demand within one or more trays 601. In some embodiments, the plurality of compartments 614 are formed by inserting a partitioning member 605 into a tray 601. In this regard, the tray 601 serves as both a pooling vessel 615 and as the plurality of reaction vessels 614. As described herein, the tray 601 may be repeatedly configured from at least a first conformation which serves as the pooling vessel 615 and from at least a second configuration which serves as the plurality of reaction vessels 614 (and where one or more reactions may independently be carried out as described herein). In some embodiments, the quantum barcoding process described herein and set forth in U.S. Pat. No. 10,144,950 may take place in each of the plurality of formed compartments.

In some embodiments, the partitionable split-pooling array 400 may be configured to include 4 reaction vessels, 8 reaction vessels, 12 reaction vessels, 16 reaction vessels, 20 reaction vessels, 24 reaction vessels, 28 reaction vessels, 32 reaction vessels, 36 reaction vessels, 40 reaction vessels, 44 reaction vessels, 48 reaction vessels, 52 reaction vessels, 56 reaction vessels, 60 reaction vessels, 64 reaction vessels, 68 reaction vessels, 72 reaction vessels, 76 reaction vessels, 80 reaction vessels, 84 reaction vessels, 88 reaction vessels, 92 reaction vessels, 96 reaction vessels, 100 reaction vessels, 104 reaction vessels, 108 reaction vessels, 112 reaction vessels, 116 reaction vessels, 120 reaction vessels, 124 reaction vessels, 128 reaction vessels, etc.

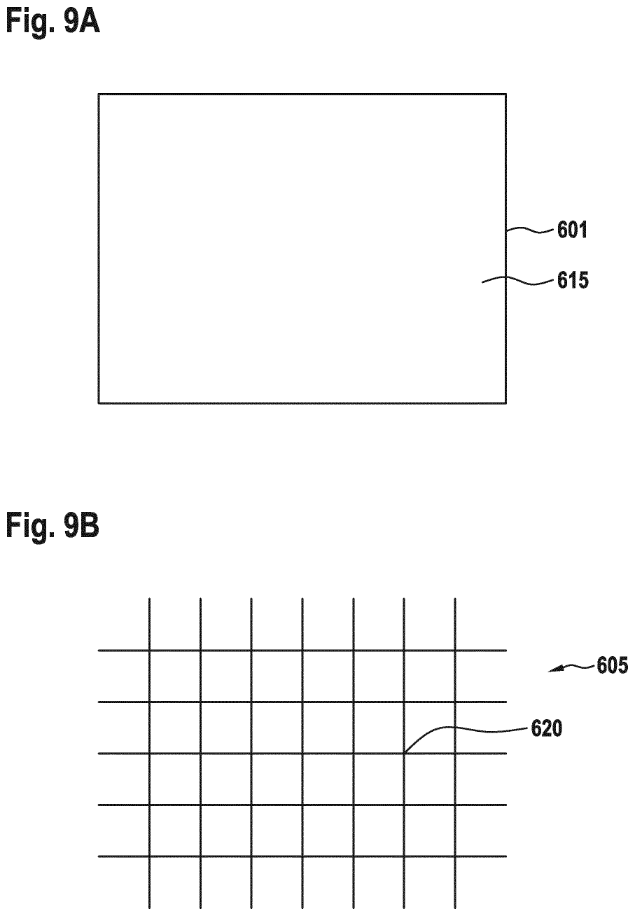

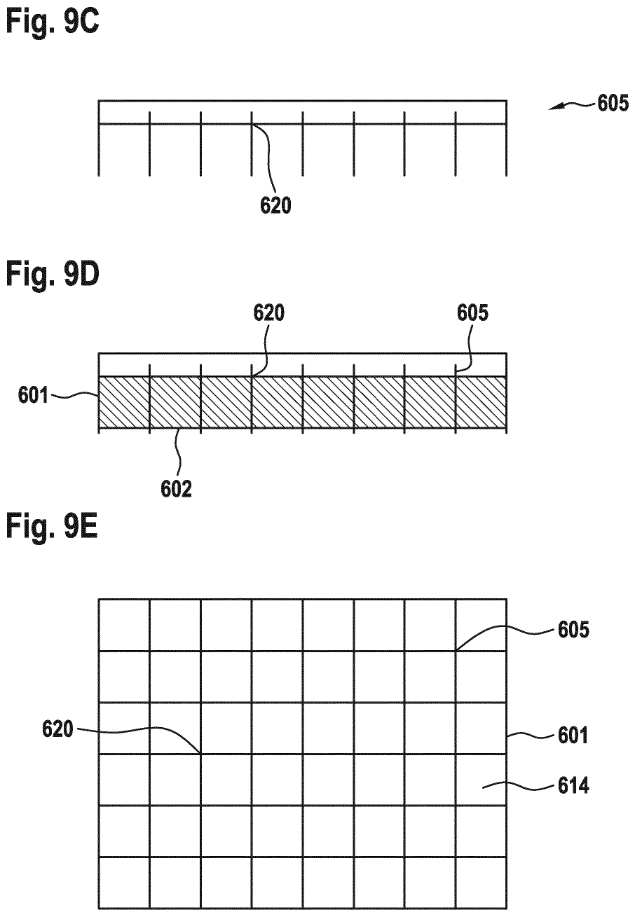

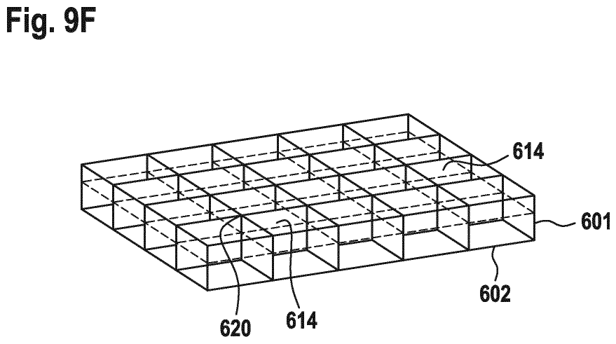

With reference to FIGS. 9A-9E, in some embodiments, the partitionable split-pooling array 400 comprises a tray 601 and a partitioning element 605. In some embodiments, the partitionable split-pooling array comprises two or more trays and two or more corresponding partitioning elements. In some embodiments, the tray 601 may have any size or shape. In some embodiments, the tray 601 is substantially circular. In other embodiments, the tray 601 is substantially ovoid. In yet other embodiments, the tray 601 is rectangular.

In some embodiments, the tray 601 is configured to receive the partitioning element 605. In this manner, the partitioning element 605 has an overall size and/or shape which is complementary to the tray 601. In some embodiments, the partitioning element 605 comprises a grid pattern 620 (see, e.g., FIG. 9B). In some embodiments, the grid pattern 620 defines the number of compartments which are formed within the tray 601. For example, the grid may be a 2×2 grid, a 2×3 grid, a 2×4 grid, a 2×5 grid, a 2×6 grid, a 2×7 grid, a 2×8 grid, a 2×9 grid, a 2×10 grid, a 2×11 grid, a 2×12 grid, etc. In some embodiments grid may be a 3×2 grid, a 3×3 grid, a 3×4 grid, a 3×5 grid, a 3×6 grid, a 3×7 grid, a 3×8 grid, a 3×9 grid, a 3×10 grid, a 3×11 grid, a 3×12 grid, etc. In some embodiments, the grid may be a4×2 grid, a 4×3 grid, a 4×4 grid, a 4×5 grid, a 4×6 grid, a 4×7 grid, a 4×8 grid, a 4×9 grid, a 4×10 grid, a 4×11 grid, a 4×12 grid, etc. In some embodiments, the grid may be a 5×2 grid, a 5×3 grid, a 5×4 grid, a 5×5 grid, a 5×6 grid, a 5×7 grid, a 5×8 grid, a 5×9 grid, a 5×10 grid, a 5×11 grid, a 5×12 grid, etc. In some embodiments, the grid may be a 6×2 grid, a 6×3 grid, a 6×4 grid, a 6×5 grid, a 6×6 grid, a 6×7 grid, a 6×8 grid, etc. In some embodiments, the grid may be a 7×2 grid, a 7×3 grid, a 7×4 grid, a 7×5 grid, a 7×6 grid, a 7×7 grid, a 7×8 grid, etc. In some embodiments, the grid may be a 4×2 grid, a 8×3 grid, a 8×4 grid, a 8×5 grid, a 8×6 grid, a 8×7 grid, a 8×8 grid, etc.

In some embodiments, the partitioning member 605 is movable from at least a first position to a second position. In some embodiments, a motor, an actuator, a cam, etc. of the split-pooling apparatus 100 moves the partitioning element 605 from a first position above the tray 601, to a second position in communication with an interior surface 602 of the tray 601. In some embodiments, a sealing engagement is formed between the partitioning element 605 (or a component of the partitioning element 605) and one or more interior surfaces 602 of the tray 601.

In some embodiments, the positioning of the partitioning element within the tray forms a plurality of compartments. In some embodiments, each formed compartment has a volume ranging from between about 1 μL to about 10 mL. In some embodiments, each formed compartment has a volume ranging from between about 10 μL to about 1 mL. In some embodiments, each formed compartment has a volume ranging from between about 100 μL to about 500 μL. In some embodiments, the sealing engagement prevents or mitigates the cross-flow of fluids, reagents, and/or particles between each formed compartment 614.

In some embodiments, the partitioning element 605 is comprised of a metal, a polymer, or a copolymer. In other embodiments, the partitioning element 605 includes a rubber, silicone, latex, or elastomeric coating to help facilitate the sealing engagement between the partitioning element 605 and the one or more interior surfaces 602 of the tray 601.

In some embodiments, a bottom surface of the tray includes a series of troughs or other features into which the partitioning member may fit, and which helps to facilitate a sealing engagement between the tray and the partitioning element. In some embodiments, both the tray and the partitionable element are constructed from a material that helps facilitate a sealing engagement between the tray and the partitioning element.

Fluidics Module

The split-pooling apparatuses 100 of the present disclosure also include a fluidics module 402 in fluidic communication with at least a split-pooling array 400.

Dispense Devices

In some embodiments, the split pooling apparatus 100 may be communicatively coupled to one or more liquid handling components for delivering fluids, reagents, and/or particles to any component of the disclosed split-pooling apparatuses or split-pooling arrays. In some embodiments, the one or more liquid handling components may include robotic systems (which themselves may include any number of components). In some embodiments, the robotic systems are fully automated.

In some embodiments, the fluidics module 402 of the split-pooling apparatus 100 includes one or more independently operable dispense devices. In some embodiments, the one or more independently operable dispense devices may be movable, e.g. may be movably coupled to a dispense sub-assembly. In some embodiments, the one or more independently operable dispense devices are adapted to dispense any type of fluid and/or reagent as described herein. In some embodiments, the one or more independently operable dispense devices are configured to dispense particles, reagents, and/or fluids to one or more pooling vessels or to a plurality of reaction vessels. In some embodiments, each dispense device is operable between different split-pooling arrays 400. For instance, a split-pooling apparatus 100 may be configured to include two or more split-pooling arrays 400 and the dispense devices may be operable with each of the two or more split-pooling arrays 400.

In some embodiments, the one or more independently operable dispense devices includes one or more dispense nozzles or one or more pipettes (including those having removable and replaceable tips). In some embodiments, fluids and/or reagents may be dispensed using a microfluidic applicator. In other embodiments, the fluids and/or reagents are dispensed to the one or more pooling vessels and/or to the plurality of reaction vessels using drop-on-demand technology, such as where discrete droplets of reagent are dispensed to a specimen. Non-limiting examples of suitable dispense devices and dispense nozzles and the components to effectuate dispensing of fluids and/or reagents are described in U.S. Pat. Nos. 8,663,991, 6,945,128, 8,147,773, 8,790,596, 8,048,373, 8,883,509, 7,303,725, and 7,820,381, the disclosures of which are hereby incorporated by reference herein in their entireties.

In some embodiments, each of the one or more independently operable dispense devices are configured to dispense between about 1 μL to about 10 mL of fluids, reagents, and/or particles to a pooling vessel or to a plurality of reaction vessels. In some embodiments, each of the one or more independently operable dispense devices are configured to dispense between about 10 μL to about 2000 μL of fluids, reagents, and/or particles to a pooling vessel or to a plurality of reaction vessels. In other embodiments, each of the one or more independently operable dispense devices are configured to dispense between about 10 μL to about 600 μL of fluids, reagents, and/or particles to a pooling vessel or to a plurality of reaction vessels. In other embodiments, each of the one or more independently operable dispense devices are configured to dispense between about 10 μL to about 500 μL of fluids, reagents, and/or particles to a pooling vessel or to a plurality of reaction vessels. In other embodiments, each of the one or more independently operable dispense devices are configured to dispense between about 10 μL to about 400 μL of fluids, reagents, and/or particles to a pooling vessel or to a plurality of reaction vessels. In other embodiments, each of the one or more independently operable dispense devices are configured to dispense between about 10 μL to about 300 μL of fluids, reagents, and/or particles to a pooling vessel or to a plurality of reaction vessels. In other embodiments, each of the one or more independently operable dispense devices are configured to dispense between about 10 μL to about 200 μL of fluids, reagents, and/or particles to a pooling vessel or to a plurality of reaction vessels. In other embodiments, each of the one or more independently operable dispense devices are configured to dispense between about 10 μL to about 100 μL of fluids, reagents, and/or particles to a pooling vessel or to a plurality of reaction vessels. In other embodiments, each of the one or more independently operable dispense devices are configured to dispense between about 10 μL to about 60 μL of fluids, reagents, and/or particles to a pooling vessel or to a plurality of reaction vessels. In some embodiments, tips of each dispense device may be replaced after each dispense operation.

In some embodiments, each of the one or more independently operable dispense devices are communicatively coupled to the control system 401 such that each of the one or more independently operable dispense devices may be commanded to dispense a specific fluid and/or reagent in an appropriate amount to each of a pooling vessel or to one or more of the plurality of reaction vessels. For instance, the control system 401, may instruct each dispense device to dispense a first predetermined amount of one or more reagents to one or more reaction vessels during a first dispense operation and may further instruct each dispense device to dispense a second predetermined amount of one or more reagents to one or more reaction vessels during a second dispense operation.

Reservoirs

The split-pooling apparatus 100 may be fluidically coupled to any number of reservoirs 403. Non-limiting examples of reservoirs include reagent reservoirs, particle storage reservoirs, particle collection reservoirs, fluid reservoirs, waste collection reservoirs, etc. Each of the reservoirs may be fluidically coupled the independently operable one or mode dispense devices described above.

In some embodiments, each of the reservoirs 403 include a valve such that the flow of fluids from the reservoir may be controlled. In some embodiments, the volume of a fluid reservoir ranges from between about 10 μL to about 1 mL. In some embodiments, the volume of a fluid reservoir ranges from between about 1 mL to about 10 mL. In some embodiments, the volume of a particle loading reservoir ranges from between about 10 μL to about 1 mL. In some embodiments, the volume of a particle loading reservoir ranges from between about 100 μL to about 1 mL. In some embodiments, the volume of a particle collection reservoir ranges from between about 10 μL to about 1 mL. In some embodiments, the volume of a particle collection reservoir ranges from between about 1 mL to about 10 mL. In some embodiments, the volume of a reagent reservoir ranges from between about 10 μL to about 100 μL. In some embodiments, the volume of a reagent reservoir ranges from between about 100 μL to about 1 mL.

In some embodiments, the fluidics module 402 includes a separate reagent reservoir for each different reagent. In some embodiments, the number of reagent reservoirs are equal to the number of reaction vessels of a split-pooling array 400. In some embodiments, each different reagent reservoir is in fluidic communication with a different reaction vessel via a separate dispense device. In some embodiments, each reagent conduit includes a valve, e.g. a 2-way valve, such that reagent may be withdrawn from a reagent reservoir and flowed to one or more dispense devices.

Pumps

In some embodiments, the fluidics module 402 may include one or more pumps in fluidic communication with the reservoirs and/or the one or more independently operable dispense devices. In some embodiments, the pumps may be in communication with a flow sensor and/or with the control system 401.

Valves

The split-pooling apparatuses 100 or the split-pooling arrays 400 of the present disclosure may include one or more valves. In some embodiments, the valves may be disposed within any channel or conduit of any solid-pooling array 400. For instance, a microfluidic valve may be disposed within or at and end of a tube or capillary channel (e.g. such a valve may be disposed at an end of each tube or capillary channel within a nib of a channel-based split-pooling array). Likewise, a microfluidic valve may the disposed at an end of a loading channel of a loading device. Non-limiting examples of suitable microfluidic valves are described in U.S. Pat. No. 10,197,188; in U.S. Patent Publication Nos. 2008/0236668 and 2006/0180779; and in PCT Publication No. WO/2018/104516, the disclosures of which are hereby incorporated by reference herein in their entireties. In some embodiments, the microfluidic valves may be internal to the split-pooling array or may be external to the array.

In some embodiments, valves are provided within any conduit, such as conduits coupling individual components of the fluidics module 402 (e.g. coupling fluid, reagent, and/or particles dispensers to one or more reservoirs 403). In some embodiments, the valves include one or more ports, e.g. 1-port, 2-ports, or 3-ports. Any type of valve may be utilized provided that the valve allows the flow of fluid, reagents, and/or particles within the split-pooling apparatuses 100 or the split-pooling arrays 400 of the present disclosure to be regulated, e.g. starting/stopping fluid flow, controlling the quantities of fluid flow, etc. In some embodiments, the valves are controlled based on signals from the control system 401, e.g. the control system 401 may command a valve to actuate to a first position, to a second position, or a third position such that fluid, reagent, and/or particle flow may be regulated.

Control System

The split-pooling apparatus 100 of the present disclosure is communicatively coupled to a control system 401. In some embodiments, the control system may further include one or more pressure sensors, temperature sensors, and/or flow rate sensors. In some embodiments, the sensors may be coupled to the control system 401 to permit feedback control.

In some embodiments, the systems of the present disclosure a control system 401 is used to send instructions to the vacuum sources, gas sources, pumps, dispense devices, and/or valves so as to regulate a fluid flow to a pooling vessel or to one or more reaction vessels of a split-pooling array 400. By way of example, the control system 401, in some embodiments, is configured to execute a series of instructions to control or operate one or more split-pooling apparatus components to perform one or more operations, e.g. preprogrammed operations or routines, or to receive feedback from one or more sensors communicatively coupled to the system and command the one or more system components to operate (or cease to operate) depending on the sensor feedback received. In some embodiments, the one or more preprogrammed operations or routines can be performed by one or more programmable processors executing one or more computer programs to perform an action, including by operating on received sensor feedback data and commanding apparatus components based on that received feedback.

The control system 401, in some embodiments, includes one or more memories and a programmable processor. To store information, the control system 401 can include, without limitation, one or more storage elements, such as volatile memory, non-volatile memory, read-only memory (ROM), random access memory (RAM), or the like. In some embodiments, the control system 201 is a stand-alone computer, which is external to the system. The storage and/or memory device can be one or more physical apparatuses used to store data or programs on a temporary or permanent basis. In some instances, the device is volatile memory and requires power to maintain stored information. In other instances, the device is non-volatile memory and retains stored information when the digital processing device is not powered. In still other instances, the non-volatile memory comprises flash memory. The non-volatile memory can comprise dynamic random-access memory (DRAM). The non-volatile memory can comprise ferroelectric random access memory (FRAM). The non-volatile memory can comprise phase-change random access memory (PRAM). The device can be a storage device including, by way of non-limiting examples, CD-ROMs, DVDs, flash memory devices, magnetic disk drives, magnetic tapes drives, optical disk drives, and cloud computing based storage.

In some embodiments, the control system 401 is a networked computer which enables control of the system remotely. The term “programmed processor” encompasses all kinds of apparatus, devices, and machines for processing data, including by way of example a programmable microprocessor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Other Components of a Split-Pooling Apparatus

In some embodiments, the split pooling array 400, reagent reservoirs, fluid reservoirs, etc. may be in communication with one or more heating and/or cooling modules. Suitable heating and/or cooling modules include heating blocks, Peltier devices, and/or thermoelectric modules. Suitable Peltier devices include any of those described within U.S. Pat. Nos. 4,685,081, 5,028,988, 5,040,381, and 5,079,618, the disclosures of which are hereby incorporated by reference herein in their entireties.

In some embodiments, the control system 401 may be in communication with the one or more heating and/or cooling modules and command the heating and/or cooling modules to activate and heat and/or cool the split pooling array 400, reagent reservoirs, fluid reservoirs, etc. to a predetermined temperature for a predetermined amount of time. For example, a control module may direct a supply of heat from at least one heating element to the split pooling array 400 such that a predetermined temperature is reached and/or maintained. The predetermined temperature may be input to the control system by a user or may be provided within pre-programmed instructions or routines.

In some embodiments, the split pooling array 400 be in communication with one or more mixing modules, vortexes, centrifuges, rockers, etc. In some embodiments, the one or more mixing modules include one or more acoustic wave generators, such as a one or more transducers. In some embodiments, the one or more transducers are a mechanical transducers. In other embodiments, the one or more transducers are a piezoelectric transducers. In some embodiments, the one or more transducers are composed of one or more piezoelectric wafers that generates a mechanical vibration. In some embodiments, one or more surface transducers are used to distribute or mix a fluid volume on-slide. Suitable devices and methods for contactless mixing and/or agitation are described in PCT Publication No. WO/2018/215844, the disclosure of which is hereby incorporated by reference.

In some embodiments, the system may further include one or more chemical analyzers. In some embodiments, the one or more chemical analyzers may be used to detect cellular components, reagents, byproducts, etc. within a collected waste stream.

In some embodiments, the split pooling apparatus 100 may be further coupled to a sequencing device for “next generation sequencing.” The term “next generation sequencing” refers to sequencing technologies having high-throughput sequencing as compared to traditional Sanger- and capillary electrophoresis-based approaches, wherein the sequencing process is performed in parallel, for example producing thousands or millions of relatively small sequence reads at a time. Some examples of next generation sequencing techniques include, but are not limited to, sequencing by synthesis, sequencing by ligation, and sequencing by hybridization. These technologies produce shorter reads (anywhere from about 25-about 500 bp) but many hundreds of thousands or millions of reads in a relatively short time.

Examples of such sequencing devices available from Illumina (San Diego, Calif.) include, but are not limited to iSEQ, MiniSEQ, MiSEQ, NextSEQ, NoveSEQ. It is believed that the Illumina next-generation sequencing technology uses clonal amplification and sequencing by synthesis (SBS) chemistry to enable rapid sequencing. The process simultaneously identifies DNA bases while incorporating them into a nucleic acid chain. Each base emits a unique fluorescent signal as it is added to the growing strand, which is used to determine the order of the DNA sequence.

A non-limiting example of a sequencing device available from ThermoFisher Scientific (Waltham, Mass.) includes the Ion Personal Genome Machine™ (PGM™) System. It is believed that Ion Torrent sequencing measures the direct release of H+ (protons) from the incorporation of individual bases by DNA polymerase. A non-limiting example of a sequencing device available from Pacific Biosciences (Menlo Park, Calif.) includes the PacBio Sequel Systems. A non-limiting example of a sequencing device available from Roche (Pleasanton, Calif.) is the Roche 454.

Next-generation sequencing methods may also include nanopore sequencing methods. In general, three nanopore sequencing approaches have been pursued: strand sequencing in which the bases of DNA are identified as they pass sequentially through a nanopore, exonuclease-based nanopore sequencing in which nucleotides are enzymatically cleaved one-by-one from a DNA molecule and monitored as they are captured by and pass through the nanopore, and a nanopore sequencing by synthesis (SBS) approach in which identifiable polymer tags are attached to nucleotides and registered in nanopores during enzyme-catalyzed DNA synthesis. Common to all these methods is the need for precise control of the reaction rates so that each base is determined in order.

Strand sequencing requires a method for slowing down the passage of the DNA through the nanopore and decoding a plurality of bases within the channel; ratcheting approaches, taking advantage of molecular motors, have been developed for this purpose. Exonuclease-based sequencing requires the release of each nucleotide close enough to the pore to guarantee its capture and its transit through the pore at a rate slow enough to obtain a valid ionic current signal. In addition, both of these methods rely on distinctions among the four natural bases, two relatively similar purines and two similar pyrimidines. The nanopore SBS approach utilizes synthetic polymer tags attached to the nucleotides that are designed specifically to produce unique and readily distinguishable ionic current blockade signatures for sequence determination.

In some embodiments, sequencing of nucleic acids comprises via nanopore sequencing comprises: preparing nanopore sequencing complexes and determining polynucleotide sequences. Methods of preparing nanopores and nanopore sequencing are described in U.S. Patent Application Publication No. 2017/0268052, and PCT Publication Nos. WO2014/074727, WO2006/028508, WO2012/083249, and WO/2014/074727, the disclosures of which are hereby incorporated by reference herein in their entireties. In some embodiments, tagged nucleotides may be used in the determination of the polynucleotide sequences (see, e.g., PCT Publication No. WO/2020/131759, WO/2013/191793, and WO/2015/148402, the disclosures of which are hereby incorporated by reference herein in their entireties).

Analysis of the data generated by sequencing is generally performed using software and/or statistical algorithms that perform various data conversions, e.g., conversion of signal emissions into base calls, conversion of base calls into consensus sequences for a nucleic acid template, etc. Such software, statistical algorithms, and the use of such are described in detail, in U.S. Patent Application Publication Nos. 2009/0024331 2017/0044606 and in PCT Publication No. WO/2018/034745, the disclosures of which are hereby incorporated by reference herein in their entireties.

In some embodiments, the split pooling apparatus 100 may be further coupled to an apparatus for conducting polymerase chain reaction (PCR). In general, PCR is a method for increasing the concentration of a segment of a target sequence in a mixture of genomic DNA without cloning or purification. Examples of PCR techniques that can be used include, but are not limited to, quantitative PCR, quantitative fluorescent PCR (QF-PCR), multiplex fluorescent PCR (MF-PCR), real time PCR (RT-PCR), single cell PCR, restriction fragment length polymorphism PCR (PCR-RFLP), PCR-RFLP/RT-PCR-RFLP, hot start PCR, nested PCR, in situ polony PCR, in situ rolling circle amplification (RCA), bridge PCR, picotiter PCR, digital PCR, droplet digital PCR, and emulsion PCR. Polymerase chain reaction (“PCR”) is described, for example, in U.S. Pat. Nos. 4,683,202; 4,683,195; 4,000,159; 4,965,188; 5,176,995), the disclosures of each are hereby incorporated by reference herein in their entirety.

Commercially available droplet and digital droplet PCR systems are available, e.g., from Bio-Rad and ThermoFisher. Descriptions of dPCR can be found, e.g., in US20140242582; Kuypers et al. (2017) J Clin Microbiol 55:1621; and Whale et al. (2016) Biomol Detect Quantif 10:15. Droplet and digital droplet PCR systems are further described in U.S. Pat. Nos. 9,822,393 and 10,676,778, the disclosures of which are hereby incorporated by reference herein in their entireties. In some embodiments, the droplets for digital droplet PCR may be generated by any of the devices described in PCT Application No. WO/2010/036352, the disclosure of which is hereby incorporated by reference herein in its entirety.

The presently disclosed split-pooling apparatuses and/or split-pooling arrays may be partially or fully automated. As will be appreciated by those in the art, there are a wide variety of components which can be used, including, but not limited to, one or more robotic arms; plate handlers for the positioning of plates or trays; tip assemblies for sample distribution with disposable tips; washable tip assemblies for sample distribution; 96 well loading blocks; etc.

In some embodiments, the split-pooling apparatuses 100 are coupled to one or more solids dispensers which serve to dispense solid reagents and/or solid particles to a tray, a plate, a well, a channel, etc. For instance, the solids dispensers may be used to retrieve a reagent in the form of a freeze-dried pellet and transfer that freeze-dried pellet to a tray, a plate, a well, a channel, etc. In this manner, solid reagents, such as those in the form of pre-fabricated dissolvable beads, chemically releasable beads, and/or meltable beads may be delivered to a tray, a plate, a well, a channel, etc.

Fully robotic or microfluidic systems include automated fluid, reagent (liquid or solid reagents), and/or particle dispensing elements, and which may include high throughput pipetting devices or dispensers. In some embodiments, such fully robotic or microfluidic systems are capable of performing fluid, reagent (liquid or solid reagents), and/or particle manipulations such as aspiration, dispensing, mixing, transferring of solid (e.g. freeze-dried) reagents from a storage vessel to a tray, plate, well, chamber, or channel; diluting, washing, accurate volumetric transfers; retrieving, and discarding of pipet tips; and repetitive pipetting of identical volumes for multiple deliveries from a single sample aspiration. These manipulations are cross-contamination-free liquid, particle, cell, and organism transfers. This instrument performs automated replication of microplate samples to filters, membranes, and/or daughter plates, high-density transfers, full-plate serial dilutions, and high capacity operation. Suitable robotic systems which may adapted for use with the presently disclosed split-pooling apparatuses are described in U.S. Publication No. 2010/0191382 and in U.S. Pat. No. 7,875,245, the disclosures of which are hereby incorporated by reference herein in their entireties.

In some embodiments, chemically derivatized particles, plates, cartridges, tubes, magnetic particles, or other solid phase matrix with specificity to the assay components are used. The binding surfaces of microplates, tubes or any solid phase matrices include non-polar surfaces, highly polar surfaces, modified dextran coating to promote covalent binding, antibody coating, affinity media to bind fusion proteins or peptides, surface-fixed proteins such as recombinant protein A or G, nucleotide resins or coatings, and other affinity matrix are useful in this invention.

In some embodiments, platforms for multi-well plates, multi-tubes, holders, cartridges, minitubes, sonic levitation and encapsulation, deep-well plates, microfuge tubes, cryovials, square well plates, filters, chips, microchannel chips, microfluidics chips, optic fibers, beads, and other solid-phase matrices or platform with various volumes are accommodated on an upgradeable modular platform for additional capacity. This modular platform includes a variable speed orbital shaker, and multi-position work decks for source samples, sample and reagent dilution, assay plates, sample and reagent reservoirs, pipette tips, and an active wash station— In some embodiments, the methods of the invention include the use of a plate reader.

In some embodiments, interchangeable pipet heads (single or multi-channel) with single or multiple magnetic probes, affinity probes, or pipetters robotically manipulate the fluids, reagents (liquid or solid reagents), and/or particles. Multi-well or multi-tube magnetic separators or platforms manipulate fluids, reagents (liquid or solid reagents), and/or particles in single or multiple sample formats.

These robotic handling systems can utilize any number of different reagents, including buffers, reagents, samples, washes, etc.

Methods

The present disclosure is also directed to methods of using a of split-pooling apparatus 100 as described herein for split-pool synthesis, e.g. split-pool barcoding and/or quantum barcoding. In some embodiments, the split-pooling apparatus 100 may be used in any method involving a split-pool step to label one or more particles or targets associated with particles present in a mixture of many like particles. In some embodiments, the particle may be a cell or a sub-cellular macromolecular entity.

In some embodiments, any of the split-pooling apparatuses 100 described herein may be configured to carry out any of the methods described in U.S. Pat. No. 10,144,950 (including with any of the fluids and/or reagents there described), the disclosure of which is hereby incorporated by reference herein in its entirety. In some embodiments, any of the split-pooling apparatuses 100 described herein may be configured and/or operated to provide any of the uniquely labeled particles (e.g. cells) described in U.S. Pat. No. 10,144,950, e.g. a population of particles (e.g. cells) each uniquely labeled with a different series of assayable polymer subunits.

The present disclosure provides methods of (i) dividing a population of particles into a plurality of subpopulations, (ii) reacting each of the subpopulations with a different reagent, and then (iii) simultaneously pooling the reacted subpopulations back together. In some embodiments, these steps are repeated sequentially. In some embodiments, the sequential process may be repeated at least 2 times, at least 4 times, at least 6 times, at least 8 times, at least 12 times, at least 16 times, at least 20 times, at least 24 times, at least 28 times, at least 32 times, at least 36 times, at least 40 times, at least 44 times, at least 48 times, at least 56 times, at least 64 times, etc. Given that the process of dividing the particles into multiple subpopulations is random or deterministic, each of the particles may be uniquely reacted over the course of the sequential and repetitive processing to provide a particle that includes a statistically unique chemical moiety, e.g. a statistically unique barcode, label, tag, nucleotide sequence, sequence of assayable polymer subunits, etc.

FIG. 10 depicts a method of retrieving a population of particles to be processed (“retrieving”), dividing the retrieved population of particles into two or more subpopulations of particles (“dividing”), reacting each formed subpopulation of particles with a different reagent (“reacting”), pooling the reacted subpopulations of particles back together (“pooling”), and then collecting the reacted particles (“collecting”). Additional steps may be included within the method, such as steps of washing the reacted subpopulations of particles and or a step of imaging the subpopulations of particles before and/or after reaction. In some embodiments, the processed depicted by FIG. 10 is performed using a split-pooling apparatus, including any one of the split-pooling apparatuses 100 of the present disclosure.

In some embodiments, a population of particles is first retrieved (step 710) and/or provided to a split-pooling array 400. In some embodiments, a dispense device or a pipetting system (e.g. a robotic pipetting system) may be used to introduce the population of particles to the split-pooling array 400. In some embodiments, the population of particles includes cells and/or nuclei (or any combination thereof). In some embodiments, the particles have been pre-treated (such as in one or more upstream reaction chambers) with one or more reagents to facilitate further reaction, coupling and/or hybridization of one or more moieties subsequently introduced reagents. In some embodiments, the particles have been pre-treated in accordance with the methods described in U.S. Pat. No. 10,144,950, the disclosure of which is hereby incorporated by reference herein in its entirety.

Subsequently, in some embodiments, the provided population of particles are divided into two or more subpopulations of particles (step 711). In some embodiments, the provided population of particles are divided into two more subpopulations by flowing, segmenting, trapping, or corralling the particles into different reaction vessels. In some embodiments, the reaction vessels are channels. In some embodiments, the channels are tubes. In some embodiments, the channels are capillary channels. In other embodiments, the reaction vessels are formed compartments. In some embodiments, the compartments are formed within a tray. In some embodiments, the compartments are formed on the surface of an elastomeric sheet.

In some embodiments, the provided population of particles may be divided into separate channels. In other embodiments, the provided population of particles may be divided into separate capillary channels of a capillary-based spilt-pooling array, e.g. by flowing the particles into a plurality of different channels, e.g. tubes or capillary channels. In other embodiments, the provided population of particles may be divided by trapping a subset of the particles within a formed compartment of a partitionable split-pooling array. In yet other embodiments, the provided population of particles may be divided by corralling the particles into formed compartments on the surface of an elastomeric sheet of virtual-compartment split-pooling array.

Once the population of retrieved particles is divided into the separate reaction vessels, each subpopulation of particles housed in each separate reaction vessel is reacted with a different reagent (step 712). For example, the particles within a first subpopulation in a first reaction vessel may be reacted with a first reagent (e.g. a first oligonucleotide; a first chemical moiety); while the particles within a second subpopulation of in second reaction vessel may be reacted with a second reagent (e.g. a second oligonucleotide; a second chemical moiety). In some embodiments, a different reagent may be introduced to each different reaction vessel. In some embodiments, some reaction vessels of the plurality of reaction vessels may receive the same reagent. In some embodiments, the different reagents are dispensed to the reaction vessels. In other embodiments the reaction vessels are pre-treated with the reagents (e.g. a channel, tube, or capillary channel may be impregnated with a reagent; an elastomeric sheet may include an erodible coating including a reagent).

In some embodiments, the particles in each subpopulation are allowed time to react (or incubate) with each of the introduced reagents, e.g. a time period ranging from between about one minute to about 60 minutes, from about one minute to about 30 minutes, or from about one minute to about 15 minutes. Suitable fluids and reagents (e.g. assayable polymer subunits) are further described in U.S. Pat. No. 10,144,950, the disclosure of which is hereby incorporated by reference herein in its entirety.

Following the reaction of each subpopulation of particles within a different reagent, each of the subpopulations of particles are pooled together (step 713). In some embodiments, the pooling together of the different subpopulations of particles comprises transferring each of the subpopulations from each of the separate reaction vessels to pooling vessel. In some embodiments, the particles are randomly or deterministically pooled together as they are transferred from the separate reaction vessels. In some embodiments, the transferring of the randomly or deterministically separated particles from the separate reaction vessels comprises removing a partitioning element from a tray or removing a plurality of predetermined forces from a plurality of determined locations of an elastomeric sheet.

In some embodiments, the steps of dividing (step 711), reacting, reagent (step 712), optional washing, and pooling (step 713) are be repeated (step 714) a predetermined number of times, e.g. two or more times, three or more times, four or more times, five or more times, 10 or more times, 15 or more times, 20 or more times, 40 or more times, 50 or more times, etc. For example, the pooled population of particles may again be divided into different reaction vessels and differentially reacted. Suitable fluids and reagents and methods for such differential reaction are further described in U.S. Pat. No. 10,144,950, the disclosure of which is hereby incorporated by reference herein in its entirety.

In some embodiments, the particles, e.g. cells, may be washed during the step of pooling by pelleting the particles, e.g. cells, and removing the liquid. In some embodiments, the particles, e.g. cells, may be washed during the step of pooling through a centrifugation step, followed by removal of the liquid. In other embodiments, the particles may be washed after they are reacted but prior to pooling by transferring the plate or tray to a centrifuge for washing. In yet other embodiments, the particles may be washed after they are reacted but prior to pooling by attaching the particles to magnetic bead, followed by pull down, and liquid removal. In some embodiments, the particles are washed with one or more buffer solutions.

In some embodiments, the transferring of the populations of particles to and from the reaction vessels is monitored using an imaging device. In some embodiments, the monitored occurs in real-time. In some embodiments, the particles may include a tag or other label which is indicative of whether the particle has undergone one or more reactions.

Once a predetermined number of rounds (step 714) of processing have been performed, the pooled population of reacted particles is collected from the pooling chamber. The collected population of reacted particles may then be used in downstream operations. For example, each particle after having been processed may include a unique chemical moiety that may be detected such that each particle may be uniquely identified. By way of sample, each particle may include a unique concatemeric barcode sequence that may be sequenced, e.g. with next-generation sequencing, thereby facilitating single particle identification.

In some embodiments, the particles introduced to the split-pooling array (710) are pre-sorted. For example, a received sample of particles may be sorted into a first population of particles and into a second population of particles, where the first and second populations of particles have different average diameters.

In embodiments where the particles in a sample are cells, the cells may be sorted prior to any of the split-pool synthesis methods described herein. In some embodiments, tumor cells and normal cells may be pre-sorted prior to introduction to any split-pooling array. In some embodiments, it is believed that normal cells have a size ranging from between about 4 μm to about 12 μm depending, of course, on the type of cell or the tissue in which the cell originated, and whether the tissue from which the cell originated was preserved, e.g. formalin-fixed a paraffin embedded. In some embodiments, normal cells isolated from formalin-fixed tissues have a size which ranges from between about 5 μm to about 12 μm. In yet other embodiments, normal cells from fixed tissue have a size which is less than 12 μm.

In some embodiments, it is believed that tumor cells have a size ranging from between about 9 μm to about 100 μm depending, of course, on the type of cell or the tissue in which the cell originated, and whether the tissue from which the cell originated was preserved, e.g. formalin-fixed a paraffin embedded. In some embodiments, tumor cells isolated from fixed tissue have a size which ranges from between about 9 μm to about 20 μm. In other embodiments, tumor cells isolated from fixed tissue have a size which ranges from between about 9 μm to about 50 μm. In other embodiments, tumor isolated from fixed tissue cells have a size which ranges from between about 12 μm to about 25 μm. In yet other embodiments, tumors cells isolated from fixed tissue have a size which is greater than 12 μm.

In embodiments where the particles in a sample are cell nuclei, the nuclei may be sorted prior to any of the split-pool synthesis methods described herein. In some embodiments, tumor nuclei and normal nuclei may be pre-sorted prior to introduction to any split-pooling array. In some embodiments, it is believed is that normal nuclei isolated from fixed tissue have a size ranging from between about 4.5 μm to about 9 μm depending, of course, on the type of cell or the tissue in which the nuclei originated, and whether the tissue from which the nuclei originated was preserved, e.g. formalin-fixed a paraffin embedded. In other embodiments, normal nuclei have a size which ranges from between about 5 μm to about 8.5 μm. In yet other embodiments, normal cells have a size which is less than 8.5 μm. It is anticipated that normal nuclei isolated from fresh tissue may have a size range that is similar or slightly larger than those isolated from fixed tissue.

It is believed that tumor nuclei isolated from fixed tissue have a size ranging from between about 7.5 μm to about 20 μm depending, of course, on the type of cell or the tissue in which the nuclei originated, and whether the tissue from which the nuclei originated was preserved, e.g. formalin-fixed a paraffin embedded. In other embodiments, tumor nuclei have a size which ranges from between about 8.5 μm to about 20 μm. In other embodiments, tumor nuclei have a size which ranges from between about 9 μm to about 18 μm. In other embodiments, tumor nuclei have a size which ranges from between about 9.5 μm to about 15 μm. In yet other embodiments, tumors cells have a size which is greater than about 8.5 μm.

Sorting of particles, including the sorting of cells and/or cell nuclei, may be accomplished using any upstream sorting device or process. Examples of suitable upstream sorting devices include deterministic lateral displacement devices, hydrophoretic filtration devices, hydrodynamic filtration devices, microfluidic devices utilizing inertial focusing in curved channels, and microfluidic devices utilizing inertial focusing in straight channels. Additional devices and methods of sorting particles, including cells and/or nuclei, are described in PCT Application No. PCT/EP2018/058809, the disclosure of which is hereby incorporated by reference herein in its entirety.

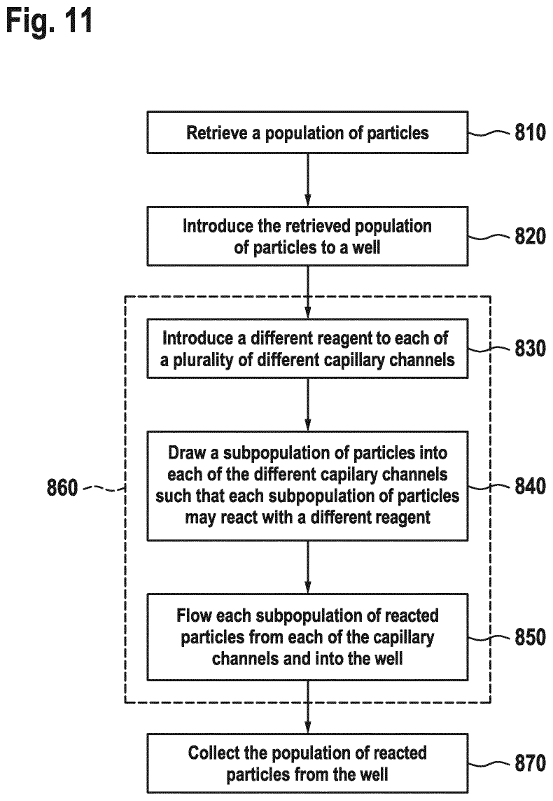

FIG. 11 depicts a method of split-pool synthesis using a channel-based split-pooling array. In some embodiments, a population of particles is first retrieved (step 810). In some embodiments, the retrieved particles have been pre-treated with one or more reagents to facilitate further reaction, coupling, and/or hybridization of one or more moieties introduced reagents. Subsequently, the retrieved population of particles is introduced to a well of the capillary-based split-pooling device (step 820). In some embodiments, a dispense device or a pipetting system (e.g. a robotic pipetting system) may be used to introduce the retrieved population of particles to the well of a capillary-based split-pooling array.

After the retrieved population of particles is introduced to the well, in some embodiments, a different reagent is introduced to each channel within a nib of a channel-based split-pooling array (step 830). In some embodiments, the channel is loaded with a solid reagent via a loading device. In some embodiments, each different reagent is allowed to dry prior to the introduction of any particles.

Next, the retrieved population of particles (such as particles within in a fluid) is divided into a plurality of subpopulations (step 840). In some embodiments, the retrieved population of particles is divided by (i) introducing the nib including the plurality of channels to the well including the retrieved population of particles; and (ii) allowing the particles to flow into each of the channels within the nib of the channel-based split-pooling array. In some embodiments, the channels are tubes. In other embodiments, the channels are capillary channels. In this manner, each channel will include a different subpopulation of particles that may independently react with each reagent pre-introduced to each channel. In some embodiments, the particles are flowed into the channels by drawing a vacuum through the channels. In some embodiments, the different subpopulations of particles within the different channel (e.g. a tube or a capillary channel) are each independently reacted with different reagents (e.g. any of the reagents described in U.S. Pat. No. 10,144,950, the disclosure of which is hereby incorporated by reference herein in its entirety).

In some embodiments, the particles in each subpopulation are allowed time to react (or incubate) with each of the introduced reagents, e.g. a time period ranging from between about one minute to about 60 minutes, from about one minute to about 30 minutes, or from about one minute to about 15 minutes. In some embodiments, the reagent provided to each of the reaction channels is at room temperature. In other embodiments, the reaction may be carried out at an elevated temperature, e.g. a temperature ranging from between about 25° C. to about 100° C., a temperature ranging from between about 25° C. to about 85° C., or a temperature ranging from between about 25° C. to about 70° C. In some embodiments, the population of retrieved particles is heated or cooled within the well to a predetermined temperature prior to being flowed to each channel.

Subsequently, each subpopulation of reacted particles is flowed from each of the channels of the nib of the channel-based split-pooling array and into the well, i.e. each subpopulation of reacted particles is pooled within the well (step 850). In some embodiments, the flowing of each subpopulation of reacted particles from each channel is facilitated by flowing a pressurized gas through each channel.

In some embodiments, each of the aforementioned steps may be repeated (step 860) a predetermined number of times, e.g. two or more times, three or more times, four or more times, five or more times, etc. For example, the pooled population of react3d particles may be flowed from the well and back into the channels (each channel having been again pre-treated with a different reagent), such that the population of reacted particles are again divided and where each newly formed subpopulation of particles is again independently reacted with a different reagent. Once all of the desired reactions have been run, the population of reacted particles are collected from the well (step 860). The population of reacted particles may then be used in downstream operations. For example, each particle after having been processed may include a unique chemical moiety that may be detected such that each particle may be uniquely identified. By way of sample, each particle, e.g. a cell or a nucleus, may include a unique concatemeric barcode sequence that may be sequenced thereby facilitating single particle identification.

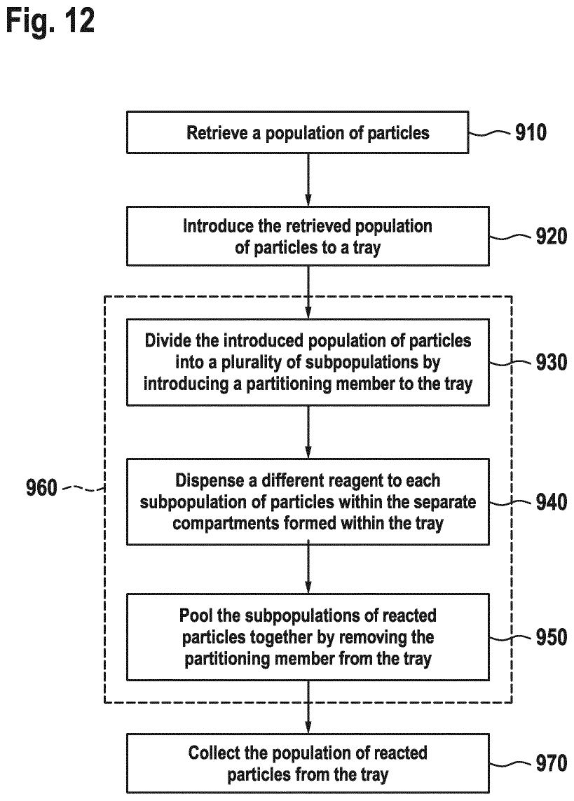

FIG. 12 depicts a method of split-pool synthesis using a partitionable split-pooling array. In some embodiments, a population of particles is first retrieved (step 910). In some embodiments, the population of retrieved particles have been pre-treated with one or more reagents to facilitate further reaction, coupling, and/or hybridization of one or more moieties introduced reagents. Subsequently, the population of retrieved particles is introduced to a tray of the partitionable split-pooling array (step 920). In some embodiments, a dispense device or a pipetting system (e.g. a robotic pipetting system) may be used to introduce the retrieved population of particles to the tray of the partitionable split-pooling array.

Next, the retrieved population of particles within the tray of the partitionable split-pooling array is divided into a plurality of subpopulations (step 930). In some embodiments, the particles are divided by introducing a partitioning element into the tray such that the introduced population of particles is divided into individual formed compartments within the tray. In this manner, each compartment formed within the tray will include a different subpopulation of particles which may be independently reacted with a different reagent.

Subsequently, a different reagent is introduced to each formed compartment within the tray (step 940). In some embodiments, each different reagent is introduced by dispensing each reagent to each different formed compartment e.g. any of the reagents described in U.S. Pat. No. 10,144,950, the disclosure of which is hereby incorporated by reference herein in its entirety). And some embodiments, a solid region is introduced into each formed compartment, such as with a robot. In some embodiments, the particles in each subpopulation are allowed time to react (or incubate) with each of the introduced reagents, e.g. a time period ranging from between about one minute to about 60 minutes, from about one minute to about 30 minutes, or from about one minute to about 15 minutes. In some embodiments, the reagent provided to each of the reaction channels is at room temperature. In other embodiments, the reaction may be carried out at an elevated temperature, e.g. a temperature ranging from between about 25° C. to about 100° C., a temperature ranging from between about 25° C. to about 85° C., or a temperature ranging from between about 25° C. to about 70° C. In some embodiments, no washing step is conducted. In other embodiments, the particles are washed. In some embodiments, the particles, e.g. cells, may be washed during the step of pooling by pelleting the particles, e.g. cells, and removing the liquid. In some embodiments, the particles, e.g. cells, may be washed during the step of pooling through a centrifugation step, followed by removal of the liquid.

Subsequently, each subpopulation of reacted particles is pooled together (step 950) by withdrawing the partitioning element from tray. In some embodiments, each of the aforementioned steps may be repeated (step 960) a predetermined number of times, e.g. two or more times, three or more times, four or more times, five or more times, etc. For example, the pooled population of reacted particles within the tray of the partitionable split-pooling array may again be divided by reintroducing the partitioning element. Once all of the desired reactions have been run, the population of reacted particles are collected from the well (step 970). The population of reacted particles may then be used in downstream operations. For example, each particle after having been processed may include a unique chemical moiety that may be detected such that each particle may be uniquely identified. By way of sample, each particle, e.g. a cell or a nucleus, may include a unique concatemeric barcode sequence that may be sequenced thereby facilitating single particle identification.

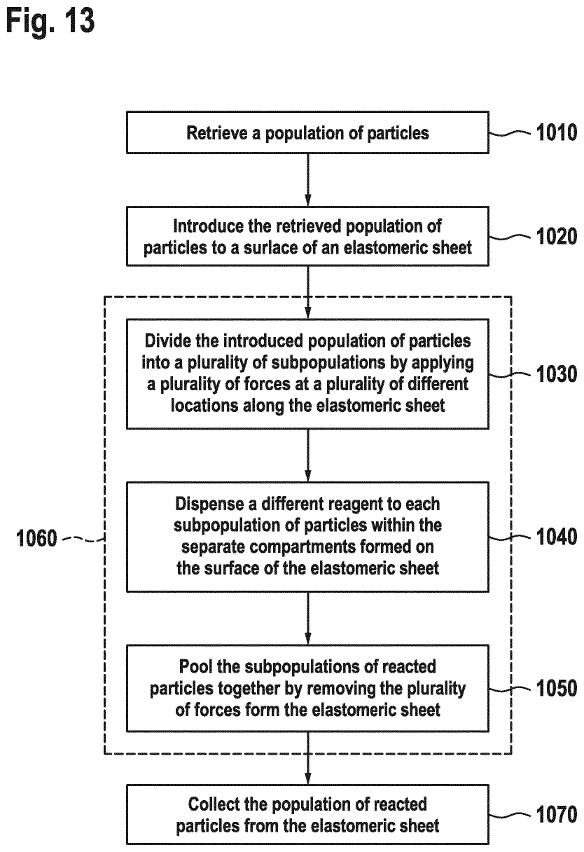

FIG. 13 depicts a method of split-pool synthesis using a “virtual compartment” split-pooling array. In some embodiments, a population of particles is first retrieved (step 1010). In some embodiments, the population of retrieved particles have been pre-treated with one or more reagents to facilitate further reaction, coupling, and/or hybridization of one or more moieties introduced reagents. Subsequently, the population of retrieved particles is introduced to a surface of an elastomeric sheet of the “virtual compartment” split-pooling array (step 1020). In some embodiments, a dispense device or a pipetting system (e.g. a robotic pipetting system) may be used to introduce the retrieved population of particles to the surface of the elastomeric sheet of the “virtual compartment” split-pooling array.

Next, the retrieved population of particles within the tray of the partitionable split-pooling array is divided into a plurality of subpopulations (step 1030). In some embodiments, the particles are divided by applying a plurality of forces to a plurality of different regions of the elastomeric sheet. In some embodiments, the plurality of forces are generated by contacting the elastomeric sheet with a movable grate. In other embodiments, the plurality of forces are generated by contacting the elastomeric sheet with a movable element having a plurality of protuberances protruding therefrom. Regardless of the method in which the forces are applied to the elastomeric sheet, the application of the forces facilitates the formation of a plurality of compartments each including a subpopulation of particles. Said another way, each compartment formed on the surface of the elastomeric sheet will include a different subpopulation of particles which may be independently reacted with a different reagent. In some embodiments, no washing step is conducted. In other embodiments, the particles are washed. In some embodiments, the particles, e.g. cells, may be washed during the step of pooling by pelleting the particles, e.g. cells, and removing the liquid. In some embodiments, the particles, e.g. cells, may be washed during the step of pooling through a centrifugation step, followed by removal of the liquid.

Subsequently, a different reagent is introduced to each formed compartment on the surface of the elastomeric sheet (step 1040). In some embodiments, each different reagent is introduced by dispensing each reagent (e.g. with a dispense device) to each different formed compartment (e.g. any of the reagents described in U.S. Pat. No. 10,144,950, the disclosure of which is hereby incorporated by reference herein in its entirety). In some embodiments, the particles in each subpopulation are allowed time to react (or incubate) with each of the introduced reagents, e.g. a time period ranging from between about one minute to about 60 minutes, from about one minute to about 30 minutes, or from about one minute to about 15 minutes. In some embodiments, the reagent provided to each of the reaction channels is at room temperature. In other embodiments, the reaction may be carried out at an elevated temperature, e.g. a temperature ranging from between about 25° C. to about 100° C., a temperature ranging from between about 25° C. to about 85° C., or a temperature ranging from between about 25° C. to about 70° C.

Subsequently, each subpopulation of reacted particles is pooled together (step 1050 by removing the plurality of forces from the elastomeric sheet. In some embodiments, each of the aforementioned steps may be repeated (step 1060) a predetermined number of times, e.g. two or more times, three or more times, four or more times, five or more times, etc. For example, the pooled population of reacted particles on the surface of the elastomeric sheet of the “virtual compartments” split-pooling array may again be divided by reintroducing the forces to the elastomeric sheet. Once all of the desired reactions have been run, the population of reacted particles are collected from the well (step 1070). The population of reacted particles may then be used in downstream operations. For example, each particle after having been processed may include a unique chemical moiety that may be detected such that each particle may be uniquely identified. By way of sample, each particle, e.g. a cell or a nucleus, may include a unique concatemeric barcode sequence that may be sequenced thereby facilitating single particle identification.

Additional Barcoding Embodiments

In some embodiments, the split-pooling apparatuses and/or the split-pooling arrays of the present disclosure facilitate a quantum barcoding process and, more specifically, facilitate one or more split-pool steps of a quantum barcoding process. In some embodiments, the split-pooling apparatuses and/or the split-pooling arrays facilitate the assembly of a cell-originating barcode (COB) a particle, such as on a cell or a component of a cell, to which a unique binding agent (UBA) has bound. In some embodiments, the split-pooling apparatuses and/or the split-pooling arrays are configured to automate the split-pool synthesis process described herein. In some embodiments, the split-pooling apparatuses and/or the split-pooling arrays are adapted for pooling and splitting cell populations two or more times, such as described herein, to achieve the step-wise assembly of the code (COB). In some embodiments, the split-pooling apparatuses and/or the split-pooling arrays are configured to achieve suitable reaction conditions for any enzymatic and non-enzymatic steps of barcode assembly to occur, such as any of those processes described in U.S. Pat. No. 10,144,950, the disclosure of which is hereby incorporated by reference herein. In some embodiments, the split-pooling apparatuses and/or the split-pooling arrays may be configured to provide a supply of buffers (such as from any of the reservoirs or vessels described herein) and may be adapted to achieve temperatures suitable for the enzymatic and non-enzymatic steps of assembling barcodes (COBs) from assayable polymeric subunits to occur.

In some embodiments, the split-pooling apparatuses and/or the split-pooling arrays facilitate the quantum barcoding workflow. Briefly, the workflow involves contacting one or more specific agents, for example unique binding agents, with each particle in a population of particles (e.g. to each cell within a population of cells). By way of example only, a UBA can be an antibody and an entity can be a cell. In some embodiments, the process further includes the step of assembling a unique barcode characteristic of each particle (described as a cell-originating barcode (COB) herein) upon each specific agent bound to the entity. By way of example only, each of the one or more types of antibodies bound to the same cell will carry the same barcode characteristic of the cell. In some embodiments, the COBs are assembled from assayable polymer subunits (APSs) in the course of the QBC workflow as described herein and as set forth in U.S. Pat. No. 10,144,950, the disclosure of which is hereby incorporated by reference.

In some embodiments, unique binding agents (UBAs) bind to target molecules and serve as a site of assembly of barcodes using the split-pooling apparatuses and/or the split-pooling arrays of the present disclosure. Binding of the UBA to the target molecule may occur external to the split-pooling apparatuses and/or the split-pooling arrays herein. In some embodiments, the split-pooling apparatuses and/or the split-pooling arrays comprises an optional upstream reaction chamber where UBA-target binding is to occur (e.g. an upstream chamber or vessel in fluidic communication with the split-pooling apparatuses and/or the split-pooling arrays). In embodiments where the split-pooling apparatuses and/or the split-pooling arrays include a UBA-target binding chamber, the chamber is configured to supply a suitable buffer and further adapted to supply temperature and mechanical conditions (e.g., agitation) for the binding to occur.

In some embodiments, and as noted above, UBAs are molecules or molecular assemblies that bind at least one target molecule. Non-limiting examples of target molecules includes proteins, nucleic acids, lipids, carbohydrates, and drugs including large and small molecule drugs. Accordingly, and in some embodiments, a UBA may be an antibody, including IgA, IgG, IgM and components or fragments of antibodies that bind specifically to the target molecule. In some embodiments, the UBA is an aptamer. Aptamers include nucleic acid aptamers (i.e., single-stranded DNA molecules or single-stranded RNA molecules) and peptide aptamers. In some embodiments, aptamers bind target molecules in a highly specific, conformation-dependent manner, typically with very high affinity, although aptamers with lower binding affinity can be selected if desired. Aptamers can be designed and optimized using the SELEX process, see Gold, J. Biol. Chem., 270(23): 13581 84 (1995); S. Jayasena, Clin. Chem., 45:1628-50 (1999). In some embodiments, the UBA is a peptoid. Peptoids are short sequences of N-substituted glycines synthetic peptides that bind proteins. In some embodiments, small size peptoids improve diffusion and kinetics of the methods described herein. Any suitable method known in the art to generate peptoids can be used, see e.g., Simon et al., PNAS 15: 89(20): 9367-9371 (1992), incorporated herein by reference. In some embodiments, the UBA is a nucleic acid (modified or unmodified DNA or RNA) complementary or at least partially complementary to the target nucleic acid (also DNA or RNA).

In some embodiments, the split-pooling apparatuses and/or the split-pooling arrays of the present disclosure are adapted to facilitate the detection of multiple target molecules. In some embodiments, the present disclosure provides a UBA population for use in a multiplexed assay. Each UBA in the population is specific for a target molecule and two or more target molecules are detected. In some embodiments, two or more target molecules are detected, and the target molecules are of the same kind, e.g., two or more protein targets. In other embodiments, two or more target molecules are detected, and the target molecules are of different kinds, e.g., a protein target and a nucleic acid target (DNA or RNA). In each instance, multiple target molecules (of the same or different kinds) present in the cell will become associated with the cell-originating barcode (COB). Using the COB, the targets will be associated with the cell of origin as described herein.

In some embodiments, the UBAs include an identity portion termed an Epitope-Specific Barcode (ESB) that identifies the UBA. For example, specific nucleic acid UBAs (probes) can be identified by their sequence or a portion thereof and do not require a separate ESB. A non-nucleic acid UBA, e.g., an antibody UBA, or a peptide and some nucleic acid UBAs, e.g., an aptamer or a random nucleic acid UBA may comprise an Epitope-Specific Barcode (ESB) that enables identifying the UBA by nucleic acid sequencing. ESB can be a nucleic acid, e.g., an oligonucleotide. Each ESB comprises a unique code that can be associated to a specific target molecule. ESB can be conjugated to the protein UBA and can be made a 5′-part or a 3′-part of a nucleic acid UBA. In certain embodiments, the ESBs comprise common linker moiety, for example, a linker oligo to which a cell originating barcode (COB) can be assembled as described in the next section. Through attachment to the COB, the ESB can be read together with the COB.

In some embodiments, binding of the ESB to the UBA may occur outside of the split-pooling apparatuses and/or the split-pooling arrays described herein. In some embodiments, binding of the ESB to the UBA may occur prior to exposing the UBA to the target. In some embodiments, the split-pooling apparatuses and/or the split-pooling arrays include an optional upstream reaction chamber where UBA-ESB binding is to occur. In such embodiments, the split-pooling apparatuses and/or the split-pooling arrays include an UBA-ESB binding chamber adapted to supply a suitable buffer and further configured to provide suitable temperature and mechanical conditions (e.g., agitation) for the binding to occur. Any of the heating and/or cooling elements and/or transducers described herein may be utilized for this purpose.

In some embodiments, the split-pooling apparatuses and/or the split-pooling arrays are configured to automate assembly of a cell origination barcode (COB). In some embodiments, each COB includes a unique code that can be associated with a specific entity of origin, e.g., a cell (or another macromolecular entity). In some embodiments, the COBs are modular structures including a plurality of different assayable polymer subunits (APS). In some embodiments, the APSs are attached in a linear combination to form a COB. In some embodiments, APSs and COBs include nucleic acids which can be sequenced with or without a prior amplification step. In some embodiments, detection of the COB sequence allows for the detection of the presence of the target molecule in the mixture (qualitative analysis). By way of example, when using fluorescent labels, a COB having a unique identity or unique spectral signature is associated with a UBA that recognizes a specific target molecule or a portion thereof. In some embodiments, detection of the COB signal, such as the spectral code of a fluorescently labeled COB allows detection of the presence of the target molecule in the mixture (qualitative analysis). Other examples of qualitative and quantitative detection of COBs are described in detail in U.S. Pat. No. 10,144,950, the disclosure of which is hereby incorporated by reference herein in its entirety.

In some embodiments, a COB may be assembled by stepwise addition of assayable polymer subunits (APSs) including, e.g., oligonucleotides. Any of the methods described herein of repeatedly and sequentially splitting, reacting, and pooling may be utilized to assembly any COB from any different APSs. In some embodiments, the COB can be attached to the UBA via a common linker (CL) to which the first APS is annealed or ligated. The assembly of COBs and their optional attachment to common linkers is described in detail in U.S. Pat. No. 10,144,950, the disclosure of which is hereby incorporated by reference herein in its entirety.

In some embodiments, the assembly of cell originating barcodes (COBs) from assayable polymer subunits (APSs) involves a process of split-pool. In some embodiments, the split-pooling apparatuses and/or the split-pooling arrays are configured to pool and split the cells into reaction vessels. In some embodiments, the split-pooling apparatuses and/or the split-pooling arrays are configured to introduce the sub-code subunits (APSs) to the cells in the “split” step. In this process, the sample is split into multiple reaction vessels, and a different APS is flowed into each of the reaction vessels. After binding of the APS to the growing COB, the split sample is pooled back together. In the next round, the sample is split again into multiple reaction vessels and a different APS is flowed into each other reaction vessels. In some embodiments, the split-pooling apparatuses and/or the split-pooling arrays are configured to provide conditions facilitating the subunit (APS) attachment to occur. Any of the methods described herein of repeatedly and sequentially splitting, reacting, and pooling may be utilized to assembly any COB from any different APSs.

Exemplary methods of annealing and ligating APSs together to form a COB are described in U.S. Pat. No. 10,144,950, the disclosure of which is incorporated by reference herein in its entirety. For example, each APS can be designed to selectively hybridize to an annealing region of an APS added during the previous round. Alternatively, APSs can anneal to an annealing primer added during each round and optionally be ligated together. In yet another alternative, all APSs can serially anneal to a single linker including multiple binding regions for APS specific to each round of annealing. In some embodiments, APSs are linked via CLICK chemistry, e.g., CLICK chemistry linkage of oligonucleotides, see, e.g. El-Sagheer et al. (PNAS, 108:28, 11338-11343, 2011). Many other variations of APS structure and methods of connecting APSs are described in in U.S. Pat. No. 10,144,950, the disclosure of which is hereby incorporated by reference herein in its entirety.

An alternative method of assembling a COB from a series of APSs is described in a U.S. application Ser. No. 16/250,974, filed on Jan. 17, 2019, the disclosure of which is hereby incorporated by reference herein in its entirety. Briefly, the UBA can comprise an anchor oligonucleotide to which a linker is annealed. APSs may then be annealed to the linker but instead of ligation, each APS is copied by extending the extendable end of the linker by a DNA polymerase. The assembled COB then comprises a copy of the series of annealed APSs. The APSs themselves may be optionally dissociated from the growing COB.

Each APS in a given round can comprise a unique sub-code sequence that is different from the rest of the APSs in that round. The sub-code may comprise a unique nucleotide sequence (code). Each assembled COB may comprise an additional barcode characteristic of the COB or characteristic of the sample.

Some embodiments of the present disclosure relate to the assembly of COBs on the UBA molecules (e.g., antibody molecules) bound to targets on the surface of cells. COBs can, for example, be assembled associated with UBAs targeting cell surface components such as peptide epitopes of cell surface proteins. In other embodiments, UBAs are delivered into cells or into cellular compartments where targets are present, e.g., intracellular proteins, mRNA or DNA targets. In such embodiments, COBs are assembled associated with UBAs inside the cell. Cells may be fixed to facilitate one or both of UBA binding and COB assembly inside the cell. Many cell permeabilization methods are known in the art and can be used for this purpose.

In some embodiments, the quantum barcoding (QBC) procedure is performed on bodies that are not cells, including organelles and peptide assemblies or other macromolecular assemblies where a target molecule may be present. For example, the QBC procedure may be performed on MHC-antigen and MHC-antigen-antibody complexes.

1. A split-pooling apparatus comprising: (i) a split-pooling array having (a) a well; and (b) a nib including a plurality of independently operable channels, wherein the nib comprises a shape complementary to a shape of the well; (ii) a fluidics module in fluidic communication with the split-pooling array; and (iii) a control system in communication with the fluidics module.

2. The split-pooling apparatus of claim 1, wherein the nib comprises between 4 and 128 independently operable channels.

3. The split-pooling apparatus of any one of claims 1-2, wherein the plurality of independently operable channels are tubes.

4. The split-pooling apparatus of claim of any one of claims 1-2, wherein the plurality of independently operable channels are capillary channels.

5. The split-pooling apparatus of any one of claims 1-4, wherein the plurality of independently operable channels are loaded with a reagent.

6. The split-pooling apparatus of claim 5, wherein each of the plurality of independently operable channels are loaded with a different reagent.

7. The split-pooling apparatus of any one of claims 1-6, further comprising a loading device.

8. The split-pooling apparatus of claim 7, wherein the loading device is complementary to the nib.

9. The split-pooling apparatus of any one of claim 8, wherein the loading device further comprises an injector mechanism.

10. A split-pooling apparatus comprising: (i) a split-pooling array having (a) a plate comprising a plurality of depressions arranged I a grid-like pattern, and (b) an elastomeric sheet covering each of the plurality of depressions; (ii) a fluidics module in fluidic communication with the split-pooling array; and (iii) a control system in communication with the fluidics module.

11. A split-pooling apparatus comprising: (i) a split-pooling array having (a) partitioning element comprising a plurality of members having a grid-like pattern, and (b) a tray, wherein the partitioning element is adapted to fit within the tray; (ii) a fluidics module in fluidic communication with the split-pooling array; and (iii) a control system in communication with the fluidics module.

12. A method of functionalizing particles with one or more reagents, comprising dividing a population of particles into two or more subpopulations by flowing, trapping, or corralling the particles into a plurality of different reaction vessels; reacting each subpopulation of particles with a different reagent to provide two or more reacted subpopulations of particles; and pooling the two or more reacted subpopulations of particles together into a pooling vessel.

13. A method of functionalizing particles with one or more reagents, comprising: (a) flowing a population of particles in a fluid through a plurality of channels of a split-pooling array, wherein the flowing of the population of particles through the plurality of channels randomly or deterministically divides the population of particles into two or more subpopulations of particles; (b) contacting each of the two or more subpopulations of particles with a different reagent introduced to each channel of the plurality of channels to provide two or more subpopulations of reacted particles; (c) and randomly or deterministically pooling the two or more reacted subpopulations of particles together into a pooling vessel to form a pool of reacted particles.

14. A method of functionalizing particles with one or more reagents, comprising: (a) randomly or deterministically dividing a population of particles into two or more subpopulations of particles, wherein the dividing of the population of particles comprises trapping each of the two or more subpopulation particles within a compartment formed within a tray of a split-pooling array; (b) contacting each of the two or more subpopulations of particles with a different reagent introduced to each of the formed compartments to provide two or more subpopulations of reacted particles; (c) and randomly or deterministically pooling the two or more reacted subpopulations of particles together into a pooling vessel to form a pool of reacted particles.

15. A method of functionalizing particles with one or more reagents, comprising: (a) randomly or deterministically dividing a population of particles into two or more subpopulations of particles, wherein the dividing of the population of particles comprises corralling each of the two or more subpopulation particles within a compartment formed on the surface of an elastomeric sheet of a split-pooling array; (b) contacting each of the two or more subpopulations of particles with a different reagent introduced to each of the compartments to provide two or more subpopulations of reacted particles; (c) and randomly or deterministically pooling the two or more reacted subpopulations of particles together into a pooling vessel to form a pool of reacted particles.
